(19) United States
(12) Patent Application Publication
(10) Pub. No.: US 2024/0169795 A1
(43) Pub. Date: May 23, 2024

(54) BENEFITS FOR RETAIL PURCHASES EMPLOYING DEBIT CARD ASSOCIATED WITH GAMING ESTABLISHMENT ACCOUNT MANAGEMENT SYSTEM

(71) Applicant: IGT, Las Vegas, NV (US)

(72) Inventors: Jeffery Shepherd, Reno, NV (US); Kevin Higgins, Reno, NV (US)

(21) Appl. No.: 17/992,563

(22) Filed: Nov. 22, 2022

(51) Int. Cl. G07F 17/32

(52) U.S. Cl. CPC G07F 17/3244

(57) ABSTRACT

Systems and methods that enable discounts for purchases made at an affiliated retailer using a debit card associated with a gaming establishment fund management system.

### BACKGROUND

In various embodiments, the systems and methods of the present disclosure enable discounts for purchases made at an affiliated retailer using a debit card associated with a gaming establishment fund management system.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF SUMMARY

In certain embodiments, the present disclosure relates to a system including a processor, and a memory device that stores a plurality of instructions. When executed by the processor responsive to a receipt, from a component of a debit card issuer, of data associated with a purchase transaction initiated in association with a debit card at a point-of-sale terminal, and responsive to a determination, based on a gaming establishment account that is independent of any account associated with the debit card, to authorize the purchase transaction in association with a discount obtained in exchange for a gaming establishment asset associated with a user, the instructions cause the processor to decrease a balance of the gaming establishment account by a first amount of funds, the first amount of being based on the purchase transaction and the discount, and communicate an authorization to the component of the debit card issuer to notify the point-of-sale terminal to complete the purchase transaction. When executed by the processor responsive to the receipt, from the component of the debit card issuer, of data associated with the purchase transaction initiated in association with the debit card at the point-of-sale terminal, and responsive to a determination, based on the gaming establishment account, to authorize the purchase transaction independent of any discount obtained in exchange for any gaming establishment asset associated with the user, the instructions cause the processor to decrease the balance of the gaming establishment account by a second amount of funds, the second amount of funds being based on the purchase transaction and being greater than the first amount of funds, and communicate the authorization to the component of the debit card issuer to notify the point-of-sale terminal to complete the purchase transaction.

In certain embodiments, the present disclosure relates to a system including a processor, and a memory device that stores a plurality of instructions. When executed by the processor responsive to a receipt, from a component of a debit card issuer, of data associated with a purchase transaction initiated in association with a debit card at a point-of-sale terminal and responsive to receipt, from a component of a player tracking system, of a quantity of player tracking points associated with a user to exchange for a discount on the purchase transaction, the instructions cause the processor to determine: if a balance of a gaming establishment account at least equals an amount of funds associated with the purchase transaction modified by an amount associated with the discount, and if an application of the discount on the purchase transaction complies with a discount limit. When executed by the processor responsive to the balance of the gaming establishment account at least equaling the amount of funds associated with the purchase transaction modified by the amount associated with the discount and the application of the discount on the purchase transaction complying with the discount limit, the instructions cause the processor to decrease the balance of the gaming establishment account based on the purchase transaction modified by the amount associated with the discount, and communicate an authorization to the component of the debit card issuer to notify the point-of-sale terminal to complete the purchase transaction. When executed by the processor responsive to the balance of the gaming establishment account at least equaling the amount of funds associated with the purchase transaction modified by the amount associated with the discount and the application of the discount on the purchase transaction being in violation of the discount limit, the instructions cause the processor to communicate a denial to the component of the debit card issuer to notify the point-of-sale terminal to deny the purchase transaction. When executed by the processor responsive to the balance of the gaming establishment account being less than the amount of funds associated with the purchase transaction, the instructions cause the processor to communicate the denial to the component of the debit card issuer to notify the point-of-sale terminal to deny the purchase transaction.

In certain embodiments, the present disclosure relates to a method of operating a system. Responsive to a receipt, from a component of a debit card issuer, of data associated with a purchase transaction initiated in association with a debit card at a point-of-sale terminal and responsive to a determination, based on a gaming establishment account that is independent of any account associated with the debit card, to authorize the purchase transaction in association with a discount obtained in exchange for a gaming establishment asset associated with a user, the method includes decreasing, by a processor, a balance of the gaming establishment account by a first amount of funds, the first amount of being based on the purchase transaction and the discount, and communicating an authorization to the component of the debit card issuer to notify the point-of-sale terminal to complete the purchase transaction. Responsive to the receipt, from the component of a debit card issuer, of data associated with the purchase transaction initiated in association with the debit card at the point-of-sale terminal and responsive to a determination, based on the gaming establishment account, to authorize the purchase transaction independent of any discount obtained in exchange for any gaming establishment asset associated with the user, the method includes decreasing, by the processor, the balance of the gaming establishment account by a second amount of funds, the second amount of funds being based on the purchase transaction and being greater than the first amount of funds, and communicating the authorization to the component of the debit card issuer to notify the point-of-sale terminal to complete the purchase transaction.

Additional features are described herein, and will be apparent from the following Detailed Description and the figures.

### BRIEF DESCRIPTION OF THE SEVERAL VIEWS OF THE DRAWINGS

FIG. 1 is an example configuration of the architecture of a plurality of different components of the system of the present disclosure.

FIGS. 2A and 2B are flow charts of example processes for operating a system which enables a coupon and a debit card associated with a gaming establishment account to be used in association with a potential purchase at a retail establishment.

FIG. 3 is a flow chart of an example process for operating a system which enables a discount procured with player tracking points and a debit card associated with a gaming establishment account to be used in association with a potential purchase at a retail establishment.

FIG. 4 is a flow chart of an example process for operating a system which enables player tracking points to be earned in association with a purchase at a retail establishment made using a debit card associated with a gaming establishment account.

FIG. 5 is a flow chart of an example process for operating a system which enables an incentive to be provided to a retail establishment in association with a purchase at a retail establishment made using a debit card associated with a gaming establishment account.

### DETAILED DESCRIPTION

In various embodiments, the systems and methods of the present disclosure enable discounts for purchases made at an affiliated retailer using a debit card associated with a gaming establishment fund management system.

In certain embodiments, the system of the present disclosure offers one or more benefits in association with the use of a debit card issued by a financial institution that is linked with one or more gaming establishment accounts maintained by a gaming establishment fund management system. In these embodiments, in association with a purchase transaction occurring at a retailer, if that purchase transaction involves the employment of a debit card associated with a gaming establishment fund management system, the gaming establishment fund management system (and/or another system, such as a coupon system) invokes the use of one or more coupons to apply toward the purchase transaction. In these embodiments, since the purchase transaction is funded with an amount from one or more gaming establishment accounts maintained by the gaming establishment fund management system and since the coupon available for use at the retailer is accessed in association with the gaming establishment fund management system (and/or another system, such as the coupon system), the discount available via the use of the coupon is applied as part of the purchase transaction (and not as part of a separate transaction). As such, the present disclosure provides that a debit card is operable with a network payment processor to enable financial transactions at a retailer remote and independent from any gaming establishments and further provides that the use of the debit card enables access to certain benefits (e.g., discounts) otherwise not available in association with the purchase transaction. Accordingly, to extend the reach of a loyalty program beyond the gaming establishment and to further the relationship between the gaming establishment and one or more retail establishments, the system operates to offer benefits to users, such as discounts for goods and/or services purchased at the retail establishments, as part of the purchase transaction occurring using a debit card associated with a gaming establishment fund management system.

In operation of certain embodiments, upon a component of a financial institution, such as a server associated with a bank, receiving a request for a debit card initiated purchase transaction occurring remote from a gaming establishment, such as at a retail establishment affiliated with the gaming establishment (i.e., a partner retail establishment), the component of the financial institution interacts with a component of a gaming establishment fund management system, such as a server of a cashless wagering system, to potentially fund the purchase transaction. In different embodiments, in association with the attempted purchase transaction, a component of a coupon system (which may be part of or separate from the gaming establishment fund management system) determines whether or not to apply one or more coupons or obtained discounts to the debit card initiated purchase transaction. If a determination occurs to apply one or more coupons or obtained discounts, the component of the gaming establishment fund management system determines whether or not to complete the purchase (e.g., whether the gaming establishment account has sufficient funds) using a discounted purchase price afforded by the use of the coupon or obtained discount. If a determination occurs not to apply any coupons or obtained discounts, the component of the gaming establishment fund management system determines whether or not to complete the purchase (e.g., whether the gaming establishment account has sufficient funds) using the price of the goods and/or services attempted to be purchased at the partner retail establishment. In such embodiments, if the component of the gaming establishment fund management system denies the debit card initiated purchase (with or without the application of any coupons or obtained discounts), the component of the gaming establishment fund management system notifies the component of the financial institution to deny the purchase and the component of the financial institution denies the debit card initiated transaction. On the other hand, if the component of the gaming establishment fund management system approves the debit card initiated purchase (with or without the application of any coupons or obtained discounts), the component of the gaming establishment fund management system notifies the component of the financial institution to complete the purchase and the component of the financial institution approves the debit card initiated transaction. In this instance, upon a settlement event, the component of the gaming establishment system funds the debit transaction occurring remote from the gaming establishment with funds maintained in association with the gaming establishment. Such a configuration enables couponing or discounting to be offered in association with a gaming establishment fund management system for purchases made using an associated debit card. Such a configuration further enables funds maintained in a gaming establishment account to be accessed using a debit card issued by a financial institution without the need to first transfer any funds from the gaming establishment account to any separate account, such as a debit card account maintained by the financial institution, and further without the need to wait for any fund transfer to be completed (or alternatively pay various surcharge fees to expedite any fund transfers).

It should be appreciated that unlike prior payment solutions in which if a user wanted to access their funds held in a casino account at a retail establishment outside of the casino, the user needed to first transfer their funds to a bank account (after which the user can then pay at that retail establishment outside of the casino using a debit card or credit card associated with their bank account), or alternatively first transfer their funds to an electronic wallet (after which the user can use a pre-paid debit card associated with their electronic wallet to pay at that retail establishment outside of the casino), the present disclosure enables a user to maintain their funds in a casino account while still availing themselves of the use of a debit card (issued separate from the casino) for purchases made outside of the casino with the added benefit of access to certain discounts for the use of such a debit card. Such discounts may be available via a benefit offered by the gaming establishment (provided to the user and/or the partner retail establishment), a benefit offered by the partner retail establishment (provided to the user and/or the gaming establishment), and/or a redemption by the user of a gaming establishment benefit associated with the user, such as a redemption of loyalty points by the user. In these different embodiments, by employing targeted discounting for partner retail establishments and employing the use of funds held in a gaming establishment account to make purchases at the partner retail establishment, the system of the present disclosure enables the user to realize the benefits of maintaining funds in a gaming establishment account while still having access to such funds when needed. In other words, by integrating a pre-paid open-loop debit card with funding from one or more gaming establishment accounts that directly accounts for any applicable benefits, the present disclosure enables such a debit card to function as an interface to remotely access funds from such gaming establishment accounts while offering certain benefits for such access. In addition to the benefits of offering discounts (e.g., via the application of coupons), such a configuration further enables a user with funds in a gaming establishment account, such as a cashless wagering account, to access the network payment processors accessible with a debit card without needing to manually arrange a pre-set transfer of any amounts of funds from the gaming establishment account to another account associated with the debit card to gain such access. This configuration saves users time (e.g., no time needs to be spent transferring funds from a gaming establishment account to a banking account associated with a debit card or waiting a dedicated amount of time for such a transfer to be completed) and offers operational efficiencies (e.g., reducing the number of touchpoints funds must flow through before they may be used) compared to prior payment solutions involving funds in a casino account.

In certain embodiments, following the issuance of a pre-paid debit card by a debit card issuer (e.g., a financial institution) to a user whom the gaming establishment fund management system maintains one or more gaming establishment accounts for and upon an attempted retail transaction (e.g., an attempted purchase and/or refund at a retailer) employing the debit card, a component of the debit card issuer system operates with a component of the gaming establishment fund management system, a component of a coupon system and/or a component of the retail point-of-sale system to determine whether or not to complete the attempted retail transaction with or without the application of one or more available coupons maintained by the coupon system.

If the determination is not to complete the attempted retail transaction, such as because the attempted retail transaction is not in compliance with one or more coupon limits and/or the attempted retail transaction is not in compliance with one or more limits on transactions employing the debit card as an interface to a gaming establishment account, then independent of any applicability of any coupons, the component of the debit card issuer system, the component of the gaming establishment fund management system and/or the component of the retail point-of-sale system operate to deny the attempted retail transaction.

On the other hand, if the determination is to complete the attempted retail transaction with or without the application of one or more available coupons maintained by the coupon system, the component of the debit card issuer system operates with the component of the gaming establishment fund management system, the component of the retail point-of-sale system and/or the component of the coupon system to complete the transaction and authorize, upon an occurrence of a settlement event and accounting for any discounts applied via any applicable coupons, the transfers of funds between an account maintained by the gaming establishment fund management system and an account associated with the retailer. In addition to offering coupons associated with a gaming establishment remote from the gaming establishment, such a configuration provides that unlike prior payment solutions in which funds residing in a cashless wagering account (which are fully redeemable for cash) are transferred to a closed-loop pre-paid account of a retail establishment resulting in such funds no longer being redeemable for cash, the employment of the debit card to gain access to a gaming establishment account enables funds to be accessible at the retail establishment while still residing in the cashless wagering account (and thus still being fully redeemable for cash).

It should be appreciated that unlike prior systems that required one or more inputs to transfer funds in a gaming establishment account to a banking account associated with a debit card and further required a certain amount of time, such as up to three days, for the transfer to be completed and the transferred funds to become available for use using the debit card, the present disclosure bypasses these external transfers and enables the debit card issuer system to interact, in real time, with the gaming establishment fund management system such that the funds available in a gaming establishment account are available for use employing a debit card as a gateway to such funds. As such, the system of the present disclosure offers, in addition to the benefits of real-time coupon deployment, the benefits of debit card transactions without the fund transfer friction previously encountered in moving funds from a gaming establishment account to a banking account associated with the debit card. Such a configuration provides the user greater control over their funds and, via the use of one or more coupons, more retained funds after completion of the purchase transaction at the partner retail establishment.

Accordingly, in view of the different channels of commerce available both in association with and independent of one or more gaming establishments, the system enables an open loop pre-paid debit card issued by a financial institution to be employed to access funds held in a gaming establishment account and to facilitate the transfer of funds to different accounts associated with different channels of commerce associated with or independent of one or more gaming establishments. Such transfers thus reduce the fund movement friction encountered in using funds held in a gaming establishment account to complete transactions outside of the gaming establishment network while still realizing the benefits of couponing and network payment processors offered by the use of debit cards. Such a configuration of employing an open loop pre-paid debit card to access funds maintained in one or more gaming establishment accounts further facilitates, amongst other benefits, a more cashless environment (e.g., cash does not need to be withdrawn from a gaming establishment account and then brought to a retailer, either internal to or external from the gaming establishment, to purchase goods and/or services) which increases safety (e.g., minimizing users having to carry large sums of cash associated with large sums of money and minimizing such cash being a vehicle to spread potentially harmful contagions).

In various embodiments, the present disclosure is directed to a gaming establishment fund management system including various sub-systems that are each associated with or otherwise maintain one or more electronic or virtual accounts. In these embodiments, the various accounts maintained for a user individually or collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a retail patron, individually or collectively form a resort or enterprise account (i.e., an integrated resort or gaming establishment fund management wallet) that the user may access to transfer funds and/or view balance information amongst the various accounts associated with or otherwise maintained for the user.

In various embodiments, the gaming establishment fund management system includes or is otherwise associated with one or more cashless wagering systems. Each cashless wagering system is associated with or otherwise maintain one or more cashless wagering accounts. In different embodiments, funds held in zero, one or more of these cashless wagering accounts are accessible by (or otherwise configured to be accessible by upon one or more inputs from a user and/or gaming establishment personnel) a debit card associated with such cashless wagering accounts.

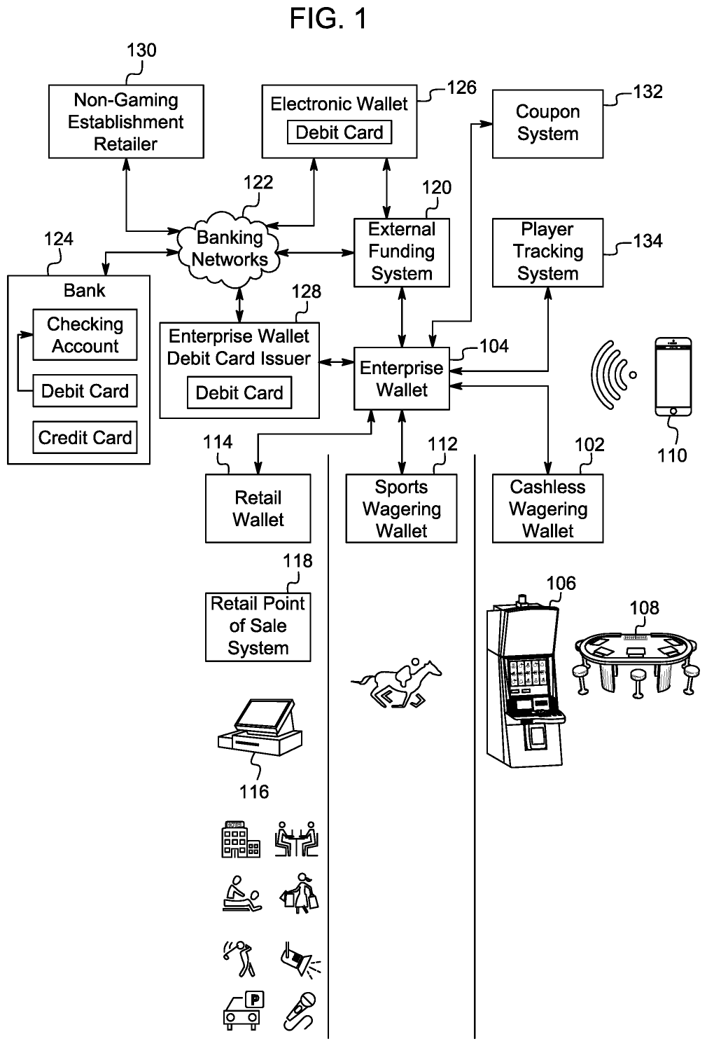

In certain embodiments, the gaming establishment fund management system includes a first cashless wagering system that maintains a first cashless wagering account. In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a card reader associated with the EGM) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the enterprise wallet 104. In this example, to facilitate the transfer of funds between this cashless wagering account and a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 104. In this example, to facilitate the transfer of funds between this cashless wagering account and a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable, amongst other activities, a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. In different embodiments, funds held in zero, one or more of these gaming establishment retail accounts are accessible by (or otherwise configured to be accessible by upon one or more inputs from a user and/or gaming establishment personnel) a debit card associated with such gaming establishment retail accounts.

In certain embodiments, such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds between this gaming establishment retail account and an account associated with a gaming establishment retailer to purchase goods and/or services from the gaming establishment retailer, the system utilizes a retail wallet identity, such as a mobile device 110 running a mobile device application that interfaces with a point-of-sale terminal 116 of a retail point-of-sale system 118 of the gaming establishment retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a gaming establishment retailer.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In certain embodiments, the gaming establishment fund management system includes or is otherwise in communication with one or more external funding sources which maintain one or more external accounts for the user. For example, as seen in FIG. 1, the gaming establishment fund management system that maintains the enterprise wallet 104 is in communication with an external funding system 120 which is in communication with a network of one or more banks or other financial institutions (i.e., the banking network 122) which operate to electronically transfer funds between the user's accounts maintained at such banks or financial institutions (i.e., bank 124 maintaining an external checking account associated with a debit card and/or a credit card) and one or more of the accounts maintained by the gaming establishment fund management system. As further seen in FIG. 1, in this example, the external funding system 120 is in communication (directly or indirectly via banking network 122) with an external electronic wallet 126 associated with a pre-paid debit card which operates to electronically transfer funds between the user's electronic wallet and one or more of the accounts maintained by the gaming establishment fund management system. In certain embodiments, funds maintained in the accounts of the external funding sources may be transferred to and/or from one or more accounts maintained by the gaming establishment fund management system. These accounts of the external funding sources include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that while illustrated as the gaming establishment fund management system being in communication with one or more external funding sources, in different embodiments, any system or sub-system of the present disclosure can be in communication with one or more external funding sources. In different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system includes a debit card issuer system. In certain other embodiments, the gaming establishment fund management system is additionally or alternatively in communication with an external debit card issuer system. In these embodiments, the debit card issuer system issues one or more debit cards for a user. For example, as seen in FIG. 1, the gaming establishment fund management system that maintains the enterprise wallet 104 is in communication with a debit card issuer system (i.e., the enterprise wallet debit card issuer system 128) to facilitate the access of an amount of funds held in one or more gaming establishment accounts via a debit card provided to the user. In this example, as also seen in FIG. 1, the network of one or more banks or other financial institutions (i.e., the banking network 122) is in communication with the debit card issuer system (i.e., the enterprise wallet debit card issuer system 128) to facilitate at least the settlement of funds held in one or more gaming establishment accounts accessed via a debit card provided to the user. It should be appreciated that while illustrated as the gaming establishment fund management system being in communication with one or more debit card issuer systems, in different embodiments, any system or sub-system of the present disclosure can be in communication with one or more debit card issuer systems. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the debit card issuer system.

In certain embodiments, the debit card is independent of any underlying account maintained at any financial institution. Rather, such a debit card operates as an interface to enable a user access to funds held in one or more gaming establishment accounts of the gaming establishment fund management system at one or more channels of commerce associated with the gaming establishment and/or independent of the gaming establishment. In certain other embodiments, the debit card is associated with an account that operates to enable a user just-in-time access to funds held in one or more gaming establishment accounts of the gaming establishment fund management system at one or more channels of commerce associated with the gaming establishment and/or independent of the gaming establishment.

In certain instances, the balance of one or more gaming establishment accounts are drawn down via transactions initiated by the debit card and accessible at a point-of-sale-terminal external from any gaming establishment channel of commerce (e.g., a non-gaming establishment retailer 130 in communication, via the banking network 122, with at least the enterprise wallet debit card issuer system 128). In certain instances, the balance of one or more gaming establishment accounts are drawn down via transactions initiated by the debit card and accessible at a gaming device, such as an EGM 106 and/or a gaming table 108a. In certain instances, the balance of one or more gaming establishment accounts are drawn down via transactions initiated by the debit card and accessible at a point-of-sale terminal 116 within a gaming establishment channel of commerce.

In certain embodiments, the gaming establishment fund management system is in communication with one or more coupon systems that offer coupons and/or discounts in association with debit card transactions occurring at a retail point-of-sale terminal external from any gaming establishment channel of commerce. In certain embodiments, the gaming establishment fund management system is integrated with a coupon system that enables coupons and/or discounts to be offered to affiliated retailers in association with a purchase of goods and/or services at the retailer using the debit card associated with the gaming establishment fund management system. In certain other embodiments, the gaming establishment fund management system is additionally or alternatively in communication with an external coupon system that enables coupons and/or discounts to be offered to affiliated retailers in association with a purchase of goods and/or services at the retailer using the debit card associated with the gaming establishment fund management system. For example, as seen in FIG. 1, the gaming establishment fund management system that maintains the enterprise wallet 104 is in communication with a coupon system (i.e., the coupon system 132) to facilitate the access to coupons (and/or additional benefits) in association with using a debit card to access an amount of funds held in one or more gaming establishment accounts. It should be appreciated that while, in certain embodiments, the gaming establishment fund management system is in communication with one or more coupon systems, in different embodiments, any system or sub-system of the present disclosure can be in communication with one or more coupon systems.

In certain embodiments, the gaming establishment fund management system is in communication with one or more gaming establishment patron management systems (e.g., player tracking system 134) that monitor activities at various points of contact associated with the gaming establishment and provides rewards, such as redeemable player tracking points, in association with such activities. It should be appreciated that while, in certain embodiments, the gaming establishment fund management system is in communication with one or more gaming establishment patron management systems, in different embodiments, any system or sub-system of the present disclosure can be in communication with one or more gaming establishment patron management systems. In different embodiments, the system utilizes a mobile device running a mobile device application, a kiosk, an interface of a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment patron management system.

In certain embodiments (not shown), the gaming establishment fund management system is in communication with one or more credit systems which each issue the user one or more lines of credit. These lines of credit are accessible to facilitate a transfer of funds from the line of credit issued by the credit system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal). It should be appreciated that the gaming establishment fund management system may be in communication with one or more credit systems, and in different embodiments, any system or sub-system of the present disclosure can be in communication with one or more credit systems. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment credit system.

In certain embodiments (not shown), the gaming establishment fund management system is also in communication with one or more credit reporting/credit risk systems which monitor and report on various accounts associated with the user. For example, the gaming establishment fund management system that maintains the enterprise wallet is in communication with one or more credit reporting and risk systems. These credit reporting and risk systems monitor and report on a credit rating and status of one or more accounts maintained for the user at various funding sources, such as various financial institutions. It should be appreciated that while, in certain embodiments, the gaming establishment fund management system being in communication with one or more credit reporting networks and one or more credit reporting/credit risk systems, in different embodiments, any system or sub-system of the present disclosure can be in communication with one or more credit reporting/credit risk systems.

In certain embodiments, the system utilizes one mobile device application to interact with the different components of the gaming establishment fund management system to, amongst other actions, access funds maintained in the different gaming establishment accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the system utilizes multiple mobile device applications to interact with the different components of the gaming establishment fund management system to, amongst other actions, access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

It should be appreciated that in different embodiments, in addition to or alternatively from utilizing a mobile device running a mobile device application to, amongst other actions, access funds associated with different gaming establishment accounts, the system utilizes a kiosk, a gaming device (e.g., an interface of an EGM or gaming table component), a service window displayed by a gaming establishment device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to, amongst other actions, access the funds associated with such gaming establishment accounts. It should be further appreciated that while illustrated in FIG. 1 as using a mobile device running a mobile device application to access funds associated with different gaming establishment accounts (e.g., a cashless wagering account and a gaming establishment retail account) as mentioned above, a physical instrument, such as a smart card or a user issued magnetic striped card may additionally or alternatively be utilized to enable a user access to such gaming establishment account.

In certain embodiments, the system enables a transfer of funds between different accounts maintained by different components associated with different gaming activities and/or non-gaming activities. In these embodiments, the system employs a service for interfacing with the various components to facilitate balance inquiry and transferring funds amongst the different accounts maintained by these various components. In certain embodiments, such a service collects data from various components and utilizes such collected data to provide a singular view of the balances (or a plurality of singular views of different groupings of balances). In certain embodiments, such a service additionally or alternatively provides facilities to enforce rules associated with the different accounts maintained by the various components. In different such embodiments, these rules include, but are not limited to, jurisdictional controls, self-imposed limits, state governmental controls and federal governmental controls, wherein the system provides the logic to determine how, and how much, to transfer from each account of the various interconnected components to satisfy a request for funds while staying within the confines of such rules. In certain embodiments, such a service additionally or alternatively tracks and coalesces transaction history across the accounts of the interconnected components of the system. In these embodiments, all transactions within the system have a “master” transaction record that ties all of the various fund transfers to a single initiating funds transfer regardless of how many accounts were withdrawn to the satisfy the original request.

In various embodiments, prior to enabling a user to receive the benefits of one or more coupons in association with a purchase of goods and/or services, a component of the coupon system operates with zero, one or more components of other systems, such as a component of the gaming establishment fund management system, a component of the debit card issuer system and/or a component of a retail point-of-sale system to determine zero, one or more coupons to associate with the user and/or the attributes of such coupons (e.g., the value of such coupons, any expiration of such coupons). In certain embodiments, to incentivize a user to conduct business with a partner retail establishment, the component of the coupon system determines one or more coupons to associate with the user. In these embodiments, to better foster the relationship between gaming establishments and various retail establishments, such as retail establishments located in areas where a relatively large number of players who visit the gaming establishment live, and to build or grow user loyalty to the gaming establishment when the user is not on property, the system utilizes coupons in association with debit card transactions funded with funds from one or more gaming establishment accounts maintained in association with the gaming establishment.

In certain embodiments, the determination to associate any coupons with the user and/or the attributes of any such coupons is based on one or more actions of a user. In one such embodiment, in exchange for signing up to participate in a player loyalty program (i.e., opening a player tracking account), the system determines to associate one or more coupons with that user. In another such embodiment, in exchange for signing up to participate in a gaming establishment fund management system program (i.e., opening a gaming establishment fund management account or linking a player tracking account to a gaming establishment fund management account), the system additionally or alternatively determines to associate one or more coupons with that user. In another such embodiment, in exchange for linking a gaming establishment fund management account with a debit card, the system additionally or alternatively determines to associate one or more coupons with that user.

In another embodiment, the system additionally or alternatively determines to associate any coupons with the user and/or the attributes of any such coupons based on the user's wagering activity. In another such embodiment, the system additionally or alternatively determines to associate any coupons with the user and/or the attributes of any such coupons based on the user's gaming establishment retail purchasing activity. In certain embodiments, the system additionally or alternatively determines to associate any coupons with the user and/or the attributes of any such coupons based on the user's collective experience at the gaming establishment, such as if the user wagers $100 on EGMs throughout a casino and spends $100 at a gaming establishment restaurant, the system determines a coupon of $25 usable at a partner non-gaming establishment restaurant to associate with the user. In another such embodiment, the system additionally or alternatively determines to associate any coupons with the user and/or the attributes of any such coupons based on the user's retail purchasing activity occurring independent of the gaming establishment.

In certain embodiments, the determination to associate any coupons with the user and/or the attributes of any such coupons is additionally or alternatively based on an identity of the user. In one such embodiment, different users having different status with the gaming establishment are offered different coupons. In another such embodiment, the system determines to associate any coupons with the user and/or the attributes of any such coupons based on determined historical preferences of the user.

In certain embodiments, the determination to associate any coupons with the user and/or the attributes of any such coupons is additionally or alternatively based on one or more parameters of the gaming establishment. For example, as part of a marketing campaign associated with the gaming establishment, the system associates one or more coupons with one or more users. In certain embodiments, a determination to associate any coupons with the user and/or a determination of the attributes of any such coupons occurs responsive to one or more inputs received from gaming establishment personnel. In other embodiments, when the coupon is determined, the amount of funds currently maintained in the various gaming establishment fund management accounts associated with various users and the current rate of return the gaming establishment is realizing on the amount of funds in the various gaming establishment fund management accounts associated with various users factor into associating one or more coupons with one or more users.

In certain embodiments, the determination to associate any coupons with the user and/or the attributes of any such coupons is additionally or alternatively based on one or more parameters of the retail establishment. For example, as part of a marketing campaign associated with the retail establishment, the system associates one or more coupons with one or more users. In this example, which users qualify for coupons is based on the user's historical retail purchasing activity at that retail establishment. In one such embodiments, a determination to associate any coupons with the user and/or a determination of the attributes of any such coupons occurs responsive to one or more inputs received from personnel associated with the retailer.

In certain embodiments, if the system determines to associate one or more coupons with the user, the system stores coupon information in one or more accounts associated with the user. In one such embodiment, the system maintains a coupon account that stores data associated with the different coupons associated with the user. In another such embodiment, the system utilizes one or more gaming establishment accounts, such as a gaming establishment fund management account (e.g., a cashless wagering account or a gaming establishment retail account) or a player tracking account to store data associated with different coupons associated with the user. In these embodiments, the associated coupons qualify as virtual coupons. In certain additional or alternative embodiments, if the system determines to associate one or more coupons with the user, physical coupons are issued to the user (wherein to redeem, the user provides the physical coupon to retail personnel and/or scans a machine-readable code printed on the physical coupon).

In certain embodiments, a coupon is associated with a specific retail establishment. In certain embodiments, a coupon is associated with a plurality of retail establishments. In certain embodiments, the plurality of retail establishments are associated with each other (e.g., sister stores at different locations or different stores located in the same mall) or independent of each other (e.g., distinct stores located remote from each other). In certain embodiments, a coupon is associated with one or more participating retail establishments within a geographic location.

In certain embodiments, a coupon is associated with one or more qualifying criteria. In these embodiments, prior to a coupon being redeemed, any qualifying criteria associated with that coupon need to be satisfied. In certain such embodiments, the qualifying criteria pertain to when that coupon may be redeemed. In certain such embodiments, the qualifying criteria additionally or alternatively pertain to the user completing one or more activities, such as the user having to make a minimum purchase amount for a coupon to become redeemable.

In certain embodiments, a coupon is associated with one or more limits or control. In these embodiments, prior to a coupon being redeemed, the gaming establishment fund management system, the debit card issuer system, the retail point-of-sale system and/or the coupon system determine whether any applicable limits or controls are in place that prevent the coupon from being redeemed. Such limits or controls offer protection to the party funding the coupon by ensuring that coupon use corresponds with the intention of the promotional program.

In certain embodiments, the system enables a gaming establishment operator to determine and activate zero, one or more coupon limits to associate with one or more coupons. In these embodiments, if any gaming establishment operator determined coupon limits are violated, the system attempts to prevent unauthorized use of such a coupon. In certain embodiments, the determination to associate one or more coupon limits is based on one or more inputs from a gaming establishment operator wherein gaming establishment personnel indicate that they would like one or more coupon limits associated with certain of (or each of) the coupons made available.

In certain embodiments, the system enables a retail point-of-sale system to determine and activate one or more coupon limits to associate with transactions undertaken by the retail point-of-sale system. In certain of these embodiments, the determination to associate one or more coupon limits is based on one or more inputs from retail personnel whom indicate that they would like one or more coupon limits associated with certain of (or each of) the coupons available to use in association with the retail point-of-sale system. In certain other of these embodiments, the determination to associate one or more coupon limits is based on one or more settings associated with the retail point-of-sale system that dictate one or more coupon limits associated with certain of (or each of) the coupons available to use in association with the retail point-of-sale system. In certain embodiments, one or more determinations are made at the retail point-of-sale terminal level wherein different terminals are associated with different coupon limits. In certain embodiments, one or more determinations are made at the retail point-of-sale system level wherein each terminal is associated with the same coupon limits.

In certain embodiments, the system enables a user, such as gaming establishment personnel, to determine and activate zero, one or more coupon limits. In these embodiments, if any user determined coupon limits are violated, the system attempts to prevent unauthorized use of such a coupon. In certain embodiments, the determination to associate one or more coupon limits is based on one or more inputs from the user wherein the user indicates that they would like one or more coupon limits associated with certain of (or each of) the coupons available to use.

In certain embodiments, the coupon limits are associated with an identity of whom may initiate a transaction, using a debit card, involving funds maintained in a gaming establishment account. For example, the gaming establishment fund management system and/or the coupon system determines that a user enrolled in player tracking system who qualifies as a bronze status member may have access to a first tier of coupons, while another user who qualifies as a platinum status member may have access to a second tier of coupons. In certain embodiments, one or more activities of the identified user may factor into the employment (or lack thereof) or coupon limits. For example, the gaming establishment fund management system and/or the coupon system adjusts a coupon limit amount based on one or more of, has the user gambled or started a gaming session recently (e.g., last day, last hour), has the user won at a gaming establishment (and if so, the amount of those winnings), and/or is the user checked into the hotel of the gaming establishment.

In certain embodiments, the coupon limits are associated with a quantity and/or an amount of transactions that attempt to apply the coupon and use a debit card to access funds maintained in a gaming establishment account over a given period of time (e.g., hourly, daily, weekly, monthly). In these embodiments, to prevent a user from employing too many coupons, the gaming establishment fund management system, the debit card issuer system, the retail point-of-sale system and/or the coupon system places a per time period limit on coupons used in association with purchases made using a debit card to access funds in a cashless wagering account. For example, if a promotion requires a user to gamble $100 and have dinner at a casino buffet to earn a coupon at a retailer, then the promotion may limit the user to earn only one coupon for a given period of time. In another example, certain coupons may be applied only one time (i.e., one time use coupons), while other coupons may be applied an unlimited number of times or up to a maximum number of times. In certain embodiments, the coupon limits pertain to the frequency of using coupons in association with accessing funds in a gaming establishment account using the debit card and/or the amounts accessed.

In certain embodiments, the coupon limits are additionally or alternatively associated with the amount of a transaction that attempts to apply the coupon and uses a debit card to access funds maintained in a gaming establishment account. In certain embodiments, the coupon limits are imposed if the coupon is for a percentage discount. For example, a coupon could be a 5% discount on dinner at any partner restaurant, but up to a $100 bill amount. In another example, a coupon that offers a percentage discount may not have any purchase limit. In certain embodiments, certain retail purchases having a value above a threshold value that trigger the use of one or more coupon limits while other retail purchases that have a value below the threshold value do not trigger such coupon limits.

In certain embodiments, the coupon limits are associated with an identity of the retailer associated with a transaction that attempts to apply the coupon and uses a debit card to access funds maintained in a gaming establishment account. In these embodiments, the gaming establishment fund management system, the debit card issuer system, the retail point-of-sale system and/or the coupon system imposes, using a Merchant Category Code (MCC) or a whitelist or blacklist of retailers, coupon limits on a type of industry or retailer thus eliminating an entire class of retailers from participating in the program.

In certain embodiments, the coupon limits are additionally or alternatively associated with the type of good and/or service associated with the transaction that attempts to apply the coupon and uses a debit card to access funds maintained in a gaming establishment account. In these embodiments, certain types of retail purchases trigger the use of one or more coupon limits while other types of retail purchases do not trigger such coupon limits. For example, a first category of purchases, such as food and beverage purchases, can be made using funds from a gaming establishment fund management account without triggering any coupon limits while a second category of purchases, such as clothing retail outlets and entertainment related charges, triggers one or more coupon limits that must be satisfied before the completion of such purchases with funds from a gaming establishment fund management account.

In certain embodiments, the coupon limits are additionally or alternatively associated with a location of the retail purchase attempted to be made that applies the coupon and uses a debit card to access funds maintained in a gaming establishment account. In these embodiments, different locations where the funds from the gaming establishment fund management account may be used are associated with different coupon limits required to use such funds.

In certain embodiments, the coupon limits are additionally or alternatively associated with a channel of commerce (in certain instances determined via the merchant identifier of the retail establishment) in which the transaction that attempts to apply the coupon and uses a debit card to access funds maintained in a gaming establishment account is attempted to be made. In these embodiments, different channels of commerce where the funds from the gaming establishment fund management account may be accessed, using the debit card, are associated with different coupon limits required to use such funds. In certain embodiments, the coupon limits are additionally or alternatively associated with a time of when the transaction that attempts to apply the coupon and uses a debit card to access funds maintained in a gaming establishment account is attempted to be made. In certain embodiments, the coupon limits are additionally or alternatively associated with an amount of funds currently maintained in a gaming establishment fund management account associated with a user. In certain embodiments, the coupon limits are additionally or alternatively associated with a current rate of consumption of the funds in one or more gaming establishment accounts maintained for the user. In one such embodiment, the rate of consumption is based on an amount of transactions made using funds from a gaming establishment fund management account over a set period of time, such as the current day. In another such embodiment, the rate of consumption is based on an amount of transactions made using funds from a gaming establishment fund management account over a rolling period of time, such as the past 24 hours.

It should be appreciated that in different embodiments, the system employs a combination of these coupon limits to determine whether or not a transaction that attempts to apply a coupon and uses a debit card to access funds maintained in a gaming establishment account is permitted. For example, coupon limits are based on whether a total amount of retail purchases made at a designated location on certain type of goods and/or services using funds from a gaming establishment fund management account accessed with a debit card are over a designated period of time. In this example, if the total amount of retail purchases made at the designated location on the identified type of goods and/or services using funds from the gaming establishment fund management account over the designated period of time meet or exceed a threshold, then the system denies the authorization of applying the coupon for subsequent transactions.

It should be further appreciated that in certain embodiments, one or more of the coupon limits may be overridden and/or adjusted by qualifying gaming establishment personnel and/or retail personnel. In these embodiments, the gaming establishment fund management system, the debit card issuer system, the retail point-of-sale system and/or the coupon system associates different levels of overriding and/or adjusting of coupon limits with different qualifying gaming establishment personnel and/or retail personnel. In these embodiments, the gaming establishment fund management system, the debit card issuer system, the retail point-of-sale system and/or the coupon system enables different levels of overriding and/or adjusting of coupon limits for different users based on one or more attributes, such as status or historical spend, of such users.

In certain embodiments, prior to enabling a user to apply a coupon in association with a purchase goods and/or services using a debit card with funds in a gaming establishment fund management account, a user must first open such an account (if needed) and procure a debit card. In one such embodiment, the debit card takes the form of a physical instrument (e.g., a smart card that stores information or a magnetic striped debit card that stores information). In another such embodiment, the debit card additionally or alternatively takes the form of a virtual instrument (e.g., a mobile device application and/or a component of a mobile device operating system that stores account information and is operable with a point-of-sale terminal). In these embodiments, utilizing an interface, such as a mobile device application being executed by a mobile device, and/or a website accessed from a browser, the user attempts to open a gaming establishment account and/or obtain a debit card through one or more interactive forms. For example, as part of opening a cashless wagering account, a user (whom has already logged into one or more gaming establishment fund management system accounts via a mobile device application) makes one or more inputs via an interface to provide certain user identifying information, such as, but not limited to, additional address details, a social security number and/or a mother's maiden name, and/or certain anticipated spending information, such as how the user intends to spend the funds withdrawn from such an account if opened. In certain embodiments, the system enables a user to enroll or otherwise sign up for such accounts via other avenues, such as via picking up an application at various locations, via a mobile application running on a mobile device, via a point-of-sale terminal, via an EGM, via a kiosk and/or via adding a gaming establishment fund management account to an existing patron account, such as a player tracking account.

Following the gaming establishment fund management system and/or the debit card issuer system determining to authorize the user to make retail purchases that attempt to apply zero, one or more coupons and use a debit card to access funds maintained in a gaming establishment account (and subject to zero, one or more applicable limits or controls), and following any required acknowledgement by the user of any required terms and conditions associated with using funds residing in a gaming establishment fund management account to purchase goods and/or services, the gaming establishment fund management system and/or the debit card issuer system notifies the user, if applicable, regarding the ways the user may apply associated coupons and/or pay for retail purchases utilizing a debit card to access funds in a gaming establishment account. For example, the gaming establishment fund management system and/or the debit card issuer system notifies the user, via a message displayed at any suitable device, via an email, via an SMS or text message, and/or via a notification displayed by a mobile device application.

In certain embodiments, to employ an associated coupon and a debit card to facilitate the use of funds from a gaming establishment account to an account associated with a retailer to purchase goods and/or services from the retailer, the user presents the debit card to potentially access the funds in the gaming establishment account for the purchase transaction. In different embodiments, the presented debit card takes the form of one or more of a smart debit card that stores gaming establishment account information, a magnetic striped debit card that stores gaming establishment account information, a smart debit card that does not store any gaming establishment account information but is associated with a debit card number that is associated with gaming establishment account information in one or more maintained databases, a magnetic striped debit card that does not store any gaming establishment account information but is associated with a debit card number that is associated with gaming establishment account information in one or more maintained databases, a mobile device application that stores gaming establishment account information, and/or a mobile device application that does not store any gaming establishment account information but is associated with a debit card number that is associated with gaming establishment account information in one or more maintained databases.

In certain such embodiments wherein the debit card (and/or any coupon attempted to be applied) is presented in virtual or electronic form using a mobile device application, such as an electronic wallet that stores debit card data (and/or coupon data), the mobile device application prompts the user to cause the mobile device to engage the point-of-sale terminal, such as prompting the user to tap the mobile device to a designated portion of the point-of-sale terminal (or otherwise moving the mobile device to within a designated distance of a designated location of the point-of-sale terminal). Such engagement initiates a pairing or linkage between the mobile device and the point-of-sale terminal, wherein the pairing or linkage between the mobile device and the point-of-sale terminal occurs via one or more applications being run or executed on the mobile device. In this example, after such engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with the debit card to the point-of-sale terminal to facilitate the potential purchase of goods and/or services.

It should be appreciated that in certain embodiments, the user needs to take one or more steps to approve a transaction to access an associated coupon and/or funds in a gaming establishment account using a debit card. In one such embodiment, the user acknowledges the approval of accessing the associated coupon and/or accessing funds in a gaming establishment account using a debit card, when needed, by entering a personal identification number (“PIN”) via a mobile device application, providing a signature and/or presenting a biometric identifier to a mobile device. In another embodiment, the user acknowledges the approval of accessing the associated coupon and/or accessing funds in a gaming establishment account using a debit card, when needed, by entering a PIN, providing a signature and/or presenting a biometric identifier to the retail point-of-sale terminal or a peripheral device associated with the retail point-of-sale terminal.

In various embodiments, upon the presentation of the debit card at an applicable point-of-sale terminal of a retail point-of-sale system, the components of the systems individually or collectively determine whether or not to apply any associated coupons and complete the attempted retail purchase using funds maintained in a gaming establishment account. In certain such embodiments, the system automatically applies any applicable coupons associated with the user (e.g., any valid and unexpired coupons applicable at least because the user has satisfied any qualifying criteria and the coupon is not in violation of any coupon limits). In certain other embodiments, the system applies any applicable coupons associated with the user (e.g., any valid and unexpired coupons applicable at least because the user has satisfied any qualifying criteria and the coupon is not in violation of any coupon limits) responsive to one or more inputs received from the user to apply any coupons, such as the user selecting the coupons to use and/or approving the coupons to be used (e.g., the user approving, via a mobile device executing a gaming establishment application, a coupon automatically selected to be applied). In these embodiments, if one or more coupons are designated to be applied, the sourcing of the purchase amount of the goods and/or services is split between funds held in the gaming establishment account (which are accessible via the debit card) and funds attributed to the coupon (which may, in certain instances, take the form of a discount to the amount needed to purchase the goods and/or services).

In certain embodiments, upon receiving data or information regarding the debit card and any associated coupon to apply, the retail point-of-sale system communicates with the debit card issuer system to request a transfer of an amount of funds to cover the cost of the intended purchase. The debit card issuer system in turn operates with the gaming establishment fund management system and the coupon system to determine the applicability of any coupons and if the gaming establishment account has adequate funds, when accounting for any applied coupons, for the intended purchase. That is, upon the requested transfer of funds to complete the debit card facilitated retail purchase using funds in a gaming establishment account, the gaming establishment fund management system logs the user into the gaming establishment account associated with the user (if necessary) and determines, when accounting for any applied coupons, whether to authorize the transfer of an amount of funds necessary to complete the transaction. In these embodiments, if an applicable coupon is applied to offset at least part of the requested amount of funds to complete the transaction (i.e., the transaction can be completed with a reduced amount of funds from the gaming establishment account), the component of the gaming establishment fund management system (e.g., one or more servers of the gaming establishment fund management system) determines whether the gaming establishment account includes an amount of funds at least equal to the reduced amount of funds to complete the transaction. In these embodiments, if an applicable coupon is not applicable to offset any of the requested amount of funds to complete the transaction, the component of the gaming establishment fund management system determines whether the gaming establishment account includes an amount of funds at least equal to the non-reduced amount of funds to complete the transaction.

If the gaming establishment fund management system indicates that the gaming establishment account lacks adequate funds (when accounting for any applicable coupons) for the purchase, the gaming establishment fund management system denies this sale transaction of the goods and/or services using the gaming establishment account. One or more denial messages of the sale transaction of the goods and/or services using the gaming establishment account are communicated to the debit card issuer system which communicates such denial messages to the retail point-of-sale system.

On the other hand, if the gaming establishment fund management system confirms the presence of adequate funds in the gaming establishment account (when accounting for any applicable coupons), the gaming establishment fund management system authorizes the sale of the goods and/or services. The gaming establishment fund management system then proceeds to modify a balance of the gaming establishment account to reflect a debit (which factors in any amount offset by any coupons) to cover the purchased goods and/or services. The amount to cover the purchased goods and/or services with funds in the gaming establishment account plus any applicable funds offered via the use of any applied coupons are subsequently transferred, as part of a settlement process, from a backing account associated with the gaming establishment account to a retailer bank account associated with the retailer.

In addition to reducing the balance of the gaming establishment account to cover the costs of the goods and/or services (minus any amount of the costs of the goods and/or services attributable to the use of the coupon), the coupon system updates one or more databases to reflect the usage of the coupon. In different embodiments, depending on whether the coupon is a one time use coupon or a multiple use coupon, the designation of the coupon as being used determines a use state of the coupon in the database.

In addition to updating any applicable coupon database to reflect the use of one or more coupons and after accounting for the purchase price of the goods and/or services by reducing, when accounting for any applied coupons, a balance of the gaming establishment account, the gaming establishment fund management system communicates one or more authorization messages of the sale transaction of the goods and/or services to the debit card issuer system which communicates such authorization messages to the retail point-of-sale system to complete the sale of the goods and/or services. Such a completed purchase of the goods and/or services is associated with a transaction identification which one or more components of the system store for reporting purposes.

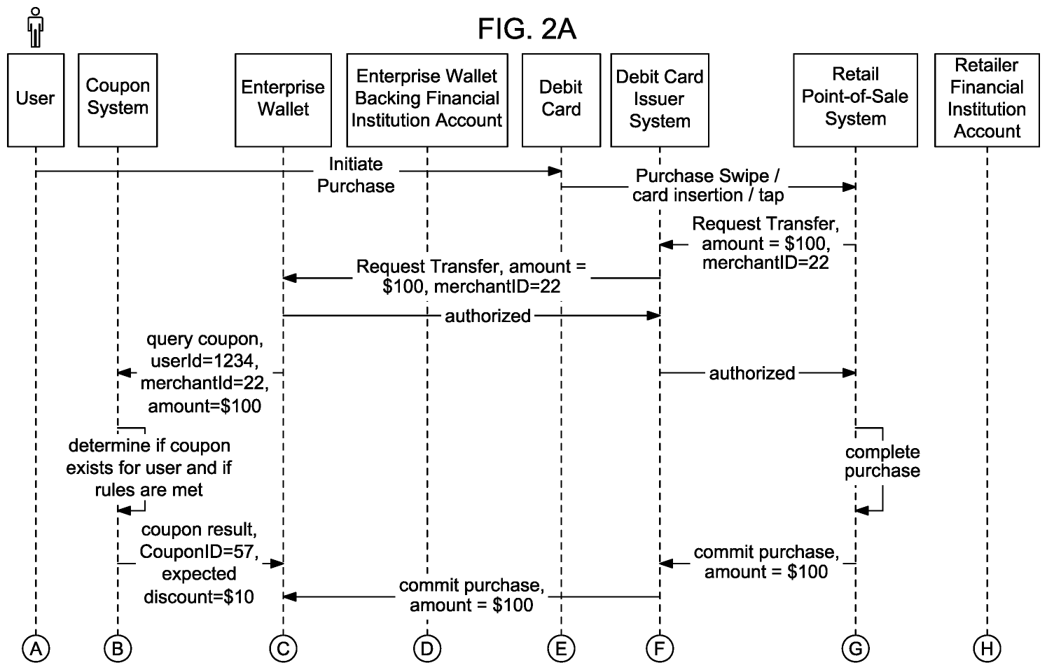

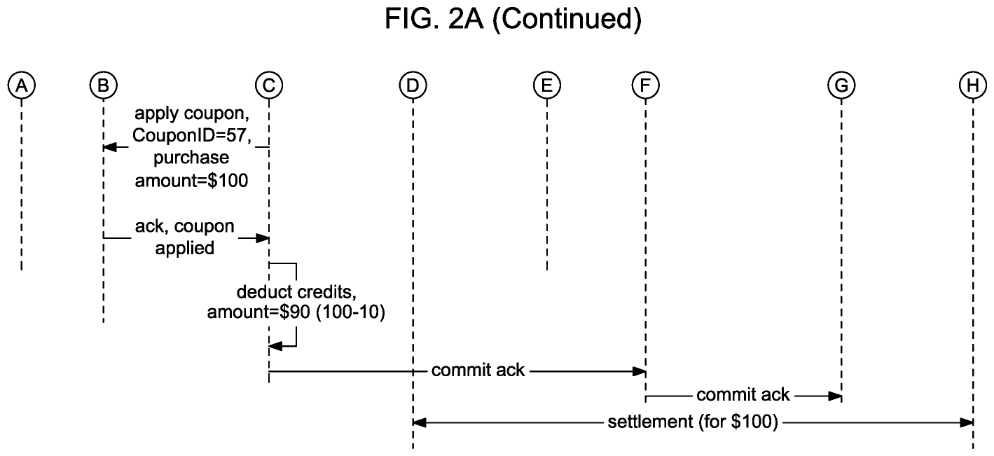

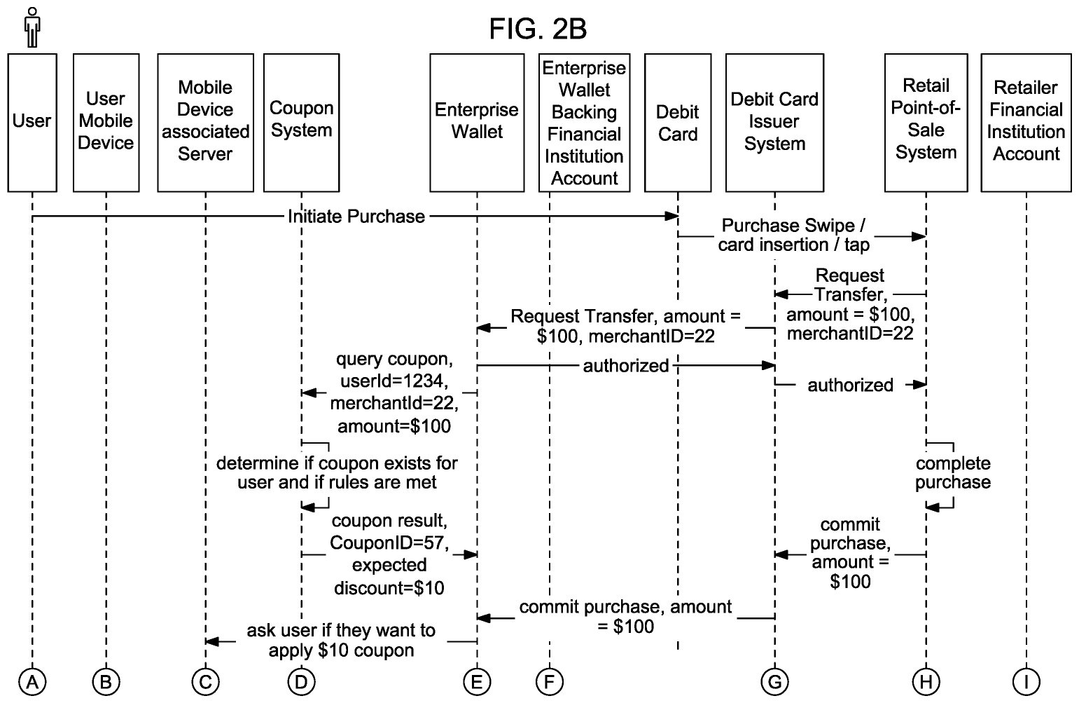

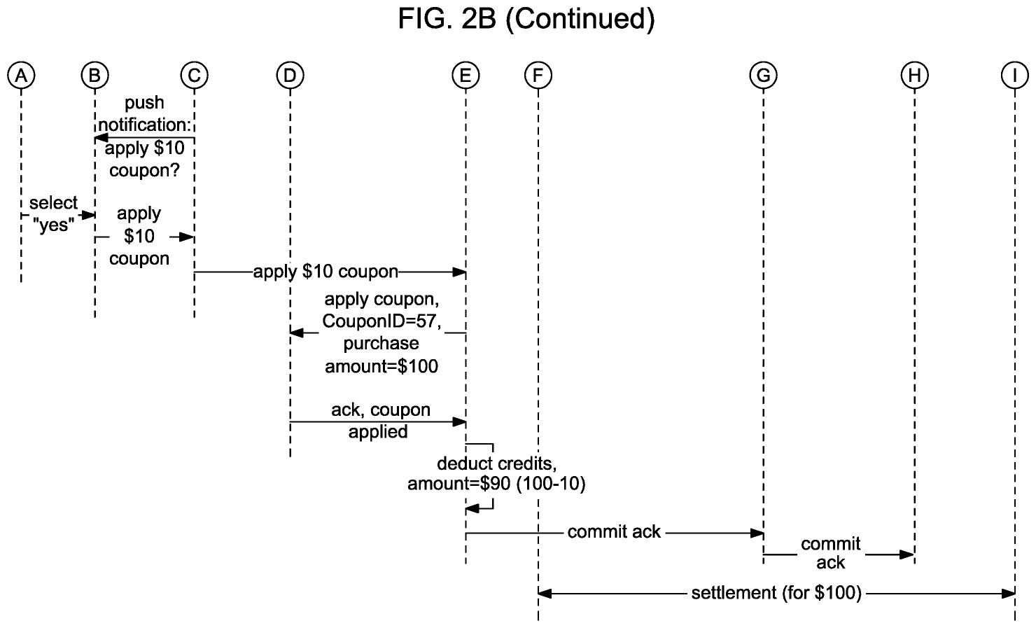

Accordingly, in various embodiments, the system of the present disclosure enables one or more coupons to be applied in association with a debit card that is used to access funds in a gaming establishment account to potentially purchase goods and/or services from a retailer, such as a retailer operating independent of any gaming establishment. In one such example, as seen in FIG. 2A (which illustrates the described interactions between the user, the gaming establishment fund management system, the debit card issuer system, the coupon system, the retail point-of-sale system and the financial institutions that maintain accounts associated with the gaming establishment fund management system and the retail point-of-sale system to settle fund transfers), certain embodiments of automatically using one or more coupons and a debit card to access gaming establishment held funds to complete a purchase transaction includes presenting the debit card to a retail point-of-sale system which interfaces with the debit card issuer system that operates with the gaming establishment fund management system (i.e., the enterprise wallet) and the coupon system to approve or deny the attempted purchase transaction and communicate information back to the debit card issuer system and the retail point-of-sale system. In another such example, as seen in FIG. 2B (which illustrates the described interactions between the user (via the user's mobile device and the server associated with the mobile device), the gaming establishment fund management system, the debit card issuer system, the coupon system, the retail point-of-sale system and the financial institutions that maintain accounts associated with the gaming establishment fund management system and the retail point-of-sale system to settle fund transfers), certain embodiments of using one or more coupons responsive to a user input and further using a debit card to access gaming establishment held funds to complete a purchase transaction includes presenting the debit card to a retail point-of-sale system which interfaces with the debit card issuer system that operates with the gaming establishment fund management system (i.e., the enterprise wallet) and the coupon system to approve or deny the attempted purchase transaction and communicate information back to the debit card issuer system and the retail point-of-sale system.

In certain embodiments, in addition to determining whether or not to complete an attempted debit card purchase transaction (using a coupon and based on a gaming establishment account having an adequate amount of funds to cover, when accounting for any offset available via the use of the coupon, the cost of the purchase transaction), the determination of whether to complete the attempted purchase transaction is based on whether the requested purchase complies with any coupon limits associated with the purchase transaction. In these embodiments, if a determination occurs that the requested purchase transaction complies with any applicable coupon limits, the gaming establishment fund management system proceeds with the determination of whether or not to authorize the purchase transaction based on the amount of funds currently associated with the gaming establishment account and any reduction amounts attributed to the coupon. On the other hand, if a determination occurs that the requested purchase transaction violates any applicable coupon limits, the gaming establishment fund management system (and/or other system that applies one or more applicable coupon limits) denies the purchase transaction. In these embodiments, the gaming establishment fund management system, the debit card issuer system, the coupon system and/or the retail point-of-sale system (or any other system applying the coupon limits), denies the attempted purchase transaction and communicates one or more denial messages.

It should be appreciated that in addition to enabling one or more coupons and a debit card to be used to access funds in a gaming establishment account to potentially purchase goods and/or services from a retailer, such as a retailer operating independent of any gaming establishment, the present disclosure enables the debit card to be used in association with a discount obtained via the user redeeming a gaming establishment asset associated with the user, such as player tracking points or other promotional balances. In these embodiments, rather than the use of coupons to reduce the amount of funds withdrawn from a gaming establishment account for a purchase made at a partner retail establishment using a debit card associated with the gaming establishment account, the system enables the user to leverage one or more gaming establishment benefits associated with the user to reduce the amount of funds withdrawn from a gaming establishment account for a purchase made at a partner retail establishment using a debit card associated with the gaming establishment account.

In certain embodiments, the system enables a user to convert, at a conversion rate, an amount of a gaming establishment loyalty points (e.g., player tracking points) to an amount of a discount applied to fund a purchase. In different embodiments, the conversion rate is static across all partner retail establishments or varies based on the partner retail establishment, the identity of the user and/or one or more activities undertaken by the user. In different embodiments, the coupon system (which interfaces with a gaming establishment patron management system to facilitate the point conversion for the discount) automatically converts (or converts responsive to a request from the user) the maximum amount of points possible to fund a discount for the user's purchase which results in limiting the amount deducted from the gaming establishment account associated with the debit card utilized to facilitate the purchase transaction. Put differently, in different embodiments, the system automatically applies any applicable discounts or applies any applicable discounts responsive to one or more inputs received from the user to apply such discounts, such as the user selecting an amount of player tracking points to convert for a discount to use and/or approving a determined discount available in exchange for player tracking points (e.g., the user approving, via a mobile device executing a gaming establishment application, a discount automatically selected to be applied).

In various embodiments, upon the presentation of the debit card at an applicable point-of-sale terminal of a retail point-of-sale system, the components of the systems individually or collectively determine whether or not to apply any discounts procured with player tracking points (and/or other gaming establishment benefits associated with the user) and complete the attempted retail purchase using funds maintained in a gaming establishment account. In these embodiments, if one or more discounts are designated to be applied in exchange for an amount of player tracking points, the sourcing of the purchase amount of the goods and/or services is split between funds held in the gaming establishment account (which are accessible via the debit card) and funds attributed to the discount.

In certain embodiments, upon receiving data or information regarding the debit card and any associated discount to apply via the exchange of player tracking points associated with the user, the retail point-of-sale system communicates with the debit card issuer system to request a transfer of an amount of funds to cover the cost of the intended purchase. The debit card issuer system in turn operates with the gaming establishment fund management system and the coupon system (which operates with the gaming establishment patron management system that maintains the balance of player tracking points for the user) to determine the applicability of any discounts and if the gaming establishment account has adequate funds, when accounting for any applied discounts, for the intended purchase. That is, upon the requested transfer of funds to complete the debit card facilitated retail purchase using funds in a gaming establishment account, the gaming establishment fund management system logs the user into the gaming establishment account associated with the user (if necessary) and determines, when accounting for any applied discounts available via a reduction in the user's balance of player tracking points maintained by the gaming establishment patron management system, whether to authorize the transfer of an amount of funds necessary to complete the transaction. In these embodiments, if an applicable discount is applied to offset at least part of the requested amount of funds to complete the transaction (i.e., the transaction can be completed with a reduced amount of funds from the gaming establishment account), the component of the gaming establishment fund management system (e.g., one or more servers of the gaming establishment fund management system) determines whether the gaming establishment account includes an amount of funds at least equal to the reduced amount of funds to complete the transaction. In these embodiments, if an applicable discount is not applicable to offset any of the requested amount of funds to complete the transaction, the component of the gaming establishment fund management system determines whether the gaming establishment account includes an amount of funds at least equal to the non-reduced amount of funds to complete the transaction.

If the gaming establishment fund management system indicates that the gaming establishment account lacks adequate funds (when accounting for any applicable discounts) for the purchase, the gaming establishment fund management system denies this sale transaction of the goods and/or services using the gaming establishment account. One or more denial messages of the sale transaction of the goods and/or services using the gaming establishment account are communicated to the debit card issuer system which communicates such denial messages to the retail point-of-sale system. On the other hand, if the gaming establishment fund management system confirms the presence of adequate funds in the gaming establishment account (when accounting for any applicable discounts), the gaming establishment fund management system authorizes the sale of the goods and/or services. The gaming establishment fund management system then proceeds to modify a balance of the gaming establishment account to reflect a debit (which factors in any amount offset by any discounts) to cover the purchased goods and/or services. The amount to cover the purchased goods and/or services with funds in the gaming establishment account plus any applicable funds offered via the use of any applied discounts are subsequently transferred, as part of a settlement process, from a backing account associated with the gaming establishment account to a retailer bank account associated with the retailer.

In addition to reducing the balance of the gaming establishment account to cover the costs of the goods and/or services (minus any amount of the costs of the goods and/or services attributable to the use of the discount), the coupon system operates with the gaming establishment patron management system to update the balance of player tracking points associated with the user.

In addition to updating different balances associated with the user (i.e., updating the gaming establishment account for part or all of the amount to fund the purchase and updating the player tracking account for any discount procured in association with the purchase), the gaming establishment fund management system communicates one or more authorization messages of the sale transaction of the goods and/or services to the debit card issuer system which communicates such authorization messages to the retail point-of-sale system to complete the sale of the goods and/or services. Such a completed purchase of the goods and/or services is associated with a transaction identification which one or more components of the system store for reporting purposes.

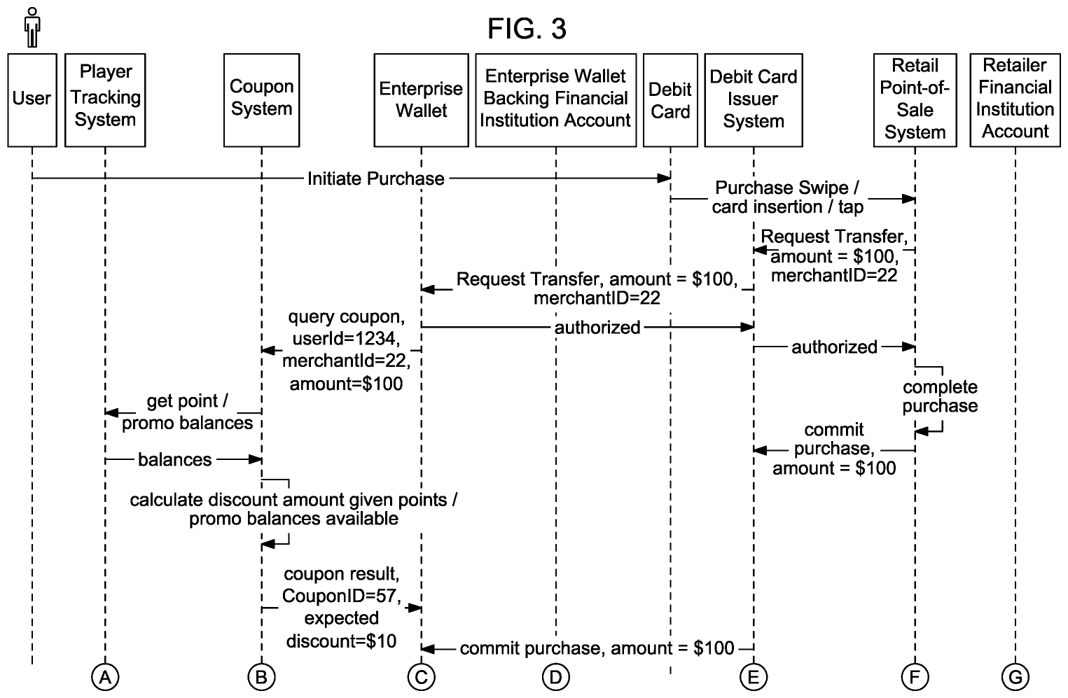

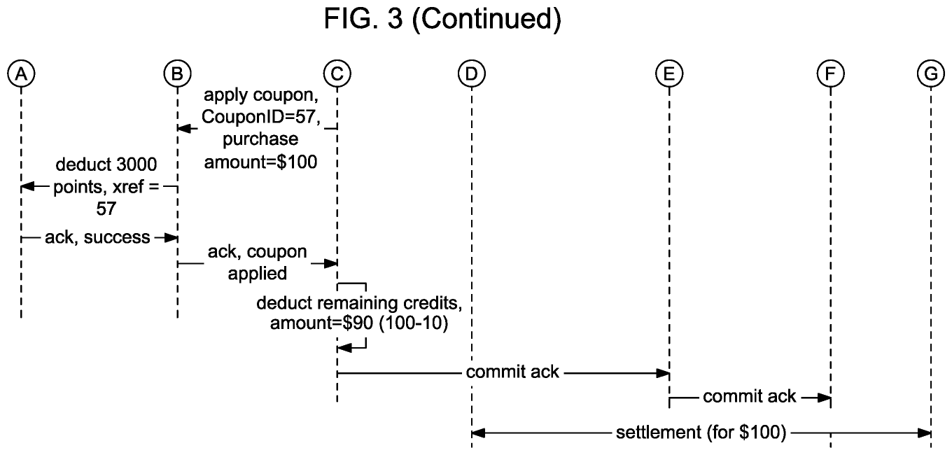

Accordingly, in various embodiments, the system of the present disclosure enables a quantity of player tracking points (and/or other gaming establishment benefits associated with the user) to be exchanged for one or more discounts to be applied in association with a debit card that is used to access funds in a gaming establishment account to potentially purchase goods and/or services from a retailer, such as a retailer operating independent of any gaming establishment. In one such example, as seen in FIG. 3 (which illustrates the described interactions between the user, the player tracking system, the gaming establishment fund management system, the debit card issuer system, the coupon system, the retail point-of-sale system and the financial institutions that maintain accounts associated with the gaming establishment fund management system and the retail point-of-sale system to settle fund transfers), certain embodiments of converting player tracking points (or other promotional balances) for one or more discounts which are used with a debit card to access gaming establishment held funds to complete a purchase transaction includes presenting the debit card to a retail point-of-sale system which interfaces with the debit card issuer system that operates with the gaming establishment fund management system (i.e., the enterprise wallet) which operates with the coupon system in communication with the player tracking system to approve or deny the attempted purchase transaction and communicate information back to the debit card issuer system and the retail point-of-sale system.

In certain embodiments, while a user may attempt to maximize the discount obtainable via converting one or more gaming establishment benefits associated with the user (e.g., player tracking points), the system employs one or more discount limits of various types or forms when applying a gaming establishment benefit associated with the user to discount a purchase. For example, the system automatically applies as many player tracking points to fund a purchase as possible up to 5% of the purchase price, thereby ensuring that the user can receive up to a 5% discount in association with every purchase made at the partner retail establishment using a debit card associated with a gaming establishment account. In different embodiments, similar to the above-described coupon limits, the discount limits may be applied over a set period of time (e.g., per day) and/or based upon a set amount available (e.g., no more than $100 of discounts per day). Moreover, similar to the above-described coupon limits, in different embodiments, the discount limits vary based on different factors such as, but not limited to, the partner retail establishment, the gaming establishment, the user (e.g., the user's player tracking status), the amount of the purchase, previous gaming establishment spend, previous partner retail establishment spend, previous discounts received.

In certain such embodiments, in addition to determining whether or not to complete an attempted debit card purchase transaction (using a discount procured from exchanging player tracking points (or other gaming establishment benefits associated with the user) and based on a gaming establishment account having an adequate amount of funds to cover, when accounting for any offset available via the use of the discount, the cost of the purchase transaction), the determination of whether to complete the attempted purchase transaction is based on whether the requested purchase complies with any discount limits associated with the purchase transaction. In these embodiments, if a determination occurs that the requested purchase transaction complies with any applicable discount limits, the gaming establishment fund management system proceeds with the determination of whether or not to authorize the purchase transaction based on the amount of funds currently associated with the gaming establishment account and any reduction amounts attributed to the discount. On the other hand, if a determination occurs that the requested purchase transaction violates any applicable discount limits, the gaming establishment fund management system (and/or other system that applies one or more applicable discount limits) denies the purchase transaction. In these embodiments, the gaming establishment fund management system, the debit card issuer system, the coupon system and/or the retail point-of-sale system (or any other system applying the discount limits), denies the attempted purchase transaction and communicates one or more denial messages.

It should be appreciated that while certain embodiments include enabling a user to obtain one or more discounts in exchange for a quantity of player tracking points (or other promotional balances associated with the user) when making a debit card facilitated purchase at a partner retail establishment, in certain additional or alternative embodiments, the system enables a user to earn player tracking points (or other promotional balances associated with the user) when making a debit card facilitated purchase at a partner retail establishment. In certain such embodiments, the gaming establishment fund management system notifies the gaming establishment patron management system, such as the player tracking system, of the amounts spent using the debit card. In these embodiments, the gaming establishment patron management system awards the user an appropriate amount of player tracking points based upon the spend using the debit card. In another embodiment, the gaming establishment fund management system determines the amount of player tracking points to award the user for retail purchases paid for using the debit card associated with the gaming establishment account. In various embodiments, the gaming establishment fund management system and/or the gaming establishment patron management system utilizes one or more criteria for determining the amount of player tracking points earned for the retail purchases paid for using the debit card associated with the gaming establishment account. Such criteria include, but not limited to, a player tracking point earning rate based on a user's player tracking status (e.g., users of a silver player tracking status earn one player tracking point for every dollar spent at a partner retail establishment using a debit card associated with a gaming establishment account, and users of a platinum player tracking status earn two player tracking points for every dollar spent at a partner retail establishment using a debit card associated with a gaming establishment account); a player tracking point earning rate based upon when the purchase at a partner retail establishment using a debit card associated with a gaming establishment account occurs (e.g., the day of the week); a player tracking point earning rate based upon an amount spent at one or more partner retail establishments using a debit card associated with a gaming establishment account over a period of time (e.g., a day, a week, or a month); a player tracking point earning rate based upon an amount wagered at a gaming establishment over a period of time; and/or a player tracking point earning rate based upon an amount of retail spend at the gaming establishment (e.g., gaming establishment hotel spend, gaming establishment spa spend, and/or gaming establishment retail spend) over a period of time.

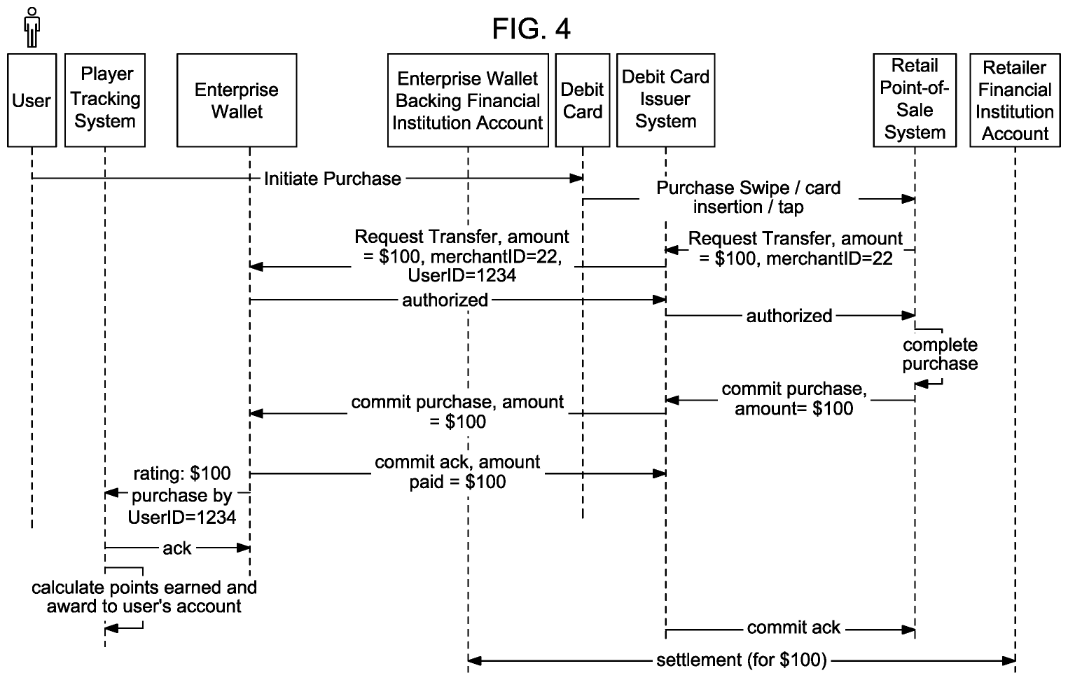

Accordingly, in various embodiments, the system of the present disclosure enables a quantity of player tracking points (and/or other gaming establishment benefits associated with the user) to be earned in association with a purchase of goods and/or services from a retailer, such as a retailer operating independent of any gaming establishment, employing a debit card that is used to access funds in a gaming establishment account. In one such example, as seen in FIG. 4 (which illustrates the described interactions between the user, the player tracking system, the gaming establishment fund management system, the debit card issuer system, the retail point-of-sale system and the financial institutions that maintain accounts associated with the gaming establishment fund management system and the retail point-of-sale system to settle fund transfers), certain embodiments of earning player tracking points (or other promotional balances) in association with a purchase made using a debit card to access gaming establishment held funds includes presenting the debit card to a retail point-of-sale system which interfaces with the debit card issuer system that operates with the gaming establishment fund management system (i.e., the enterprise wallet) which operates to approve or deny the attempted purchase transaction, which operates with a player tracking system to cause an amount of player tracking points to be earned in association with an approved purchase transaction and which operates to communicate information back to the debit card issuer system and the retail point-of-sale system.

It should be appreciated that since the present disclosure enables the debit card to be used to refund funds to a gaming establishment account as part of a refund transaction associated with a retailer, such as a retailer operating independent of any gaming establishment, the system operates to prevent certain attempted frauds in earning player tracking points (or other gaming establishment benefits associated with a user). In these embodiments, to prevent users from potentially gaming the system to earn free benefits, such as free player tracking points, by earning the benefits for purchases and then returning such purchases while retaining the benefits, the system employs certain safeguards. In one such embodiment, the gaming establishment fund management system sends purchase information to the player tracking system after the end of a billing period (e.g., after 30 days) and/or after returns are no longer reasonably allowed (e.g., after 90 days). In another such embodiment, the gaming establishment fund management system additionally or alternatively attempts to claw back previously earned benefits if the user engages in a return transaction with their debit card associated with their gaming establishment account.

In addition to enabling one or more coupons and/or discounts to be used in association with a debit card employed to access funds in a gaming establishment account to potentially purchase goods and/or services from a retailer, such as a retailer operating independent of any gaming establishment, the present disclosure enables the debit card to be used in association with an incentive provided to the retailer for partnering with the gaming establishment. In certain embodiments, in view of the positive ramifications to a gaming establishment for partnering with a retail establishment to gain access to the customers of a retailer establishment located remote from the gaming establishment and to further compensate the retail establishment for accepting funds maintained in a gaming establishment account which are accessible with a debit card associated with the gaming establishment, the gaming establishment offers incentive to the retail establishment to participate in the partnership. For example, in exchange for a retail establishment marketing the gaming establishment to their existing customer base, such as via signage, electronic communications and/or accepting a gaming establishment branded debit card associated with a gaming establishment account, the gaming establishment compensates the retail establishment for the retail establishment's marketing expenses and/or customer acquisition costs. In certain embodiments, such a promotion is accomplished by the partner retail establishment discounting certain goods and/or services in association with the promotion (e.g., a discount on a purchase if a customer can prove they are a member of a gaming establishment loyalty program) and the gaming establishment compensating the partner retail establishment for these discounts. In certain additional or alternative embodiments, when a user pays for a purchase at a partner retail establishment using a debit card associated with a gaming establishment account such a promotion is accomplished by the gaming establishment fund management system and/or the debit card issuer system transferring an amount greater than the amount requested to complete the transaction. In these embodiments, such a surplus operates as an incentive amount to compensate the retail establishment for partnering with the gaming establishment. As such, the incentive provided by the gaming establishment to the retail establishment can take the form of a discount on the purchase price of the goods and/or services (which should drive increased sales and which is offset, in whole or in part by an amount provided by the gaming establishment) and/or can take the form of an additional amount (beyond the purchase price of the goods and/or services) provided by the gaming establishment.

In various embodiments, upon the presentation of the debit card at an applicable point-of-sale terminal of a retail point-of-sale system, the components of the systems individually or collectively determine whether or not to apply any incentives and complete the attempted retail purchase using funds maintained in a gaming establishment account. In these embodiments, if one or more incentives are designated to be applied, the sourcing of the purchase amount of the goods and/or services is split between funds held in the gaming establishment account (which are accessible via the debit card) and funds attributed to the incentive supplied by the gaming establishment fund management system independent of the gaming establishment account.

In certain embodiments, upon receiving data or information regarding the debit card and any associated incentive to apply, the retail point-of-sale system communicates with the debit card issuer system to request a transfer of an amount of funds to cover the cost of the intended purchase. The debit card issuer system in turn operates with the gaming establishment fund management system to determine the applicability of any incentives and if the gaming establishment account has adequate funds, when accounting for any applied incentives, for the intended purchase. That is, upon the requested transfer of funds to complete the debit card facilitated retail purchase using funds in a gaming establishment account, the gaming establishment fund management system logs the user into the gaming establishment account associated with the user (if necessary) and determines, when accounting for any applied incentives available, whether to authorize the transfer of an amount of funds necessary to complete the transaction. In these embodiments, if an applicable incentive is applied to offset at least part of the requested amount of funds to complete the transaction (i.e., the transaction can be completed with a reduced amount of funds from the gaming establishment account), the component of the gaming establishment fund management system (e.g., one or more servers of the gaming establishment fund management system) determines whether the gaming establishment account includes an amount of funds at least equal to the reduced amount of funds required to complete the transaction. In these embodiments, if an applicable incentive is not applicable to offset any of the requested amount of funds to complete the transaction, the component of the gaming establishment fund management system determines whether the gaming establishment account includes an amount of funds at least equal to the non-reduced amount of funds to complete the transaction.

If the gaming establishment fund management system indicates that the gaming establishment account lacks adequate funds (when accounting for any applicable incentives) for the purchase, the gaming establishment fund management system denies this sale transaction of the goods and/or services using the gaming establishment account. One or more denial messages of the sale transaction of the goods and/or services using the gaming establishment account are communicated to the debit card issuer system which communicates such denial messages to the retail point-of-sale system. On the other hand, if the gaming establishment fund management system confirms the presence of adequate funds in the gaming establishment account (when accounting for any applicable incentives), the gaming establishment fund management system authorizes the sale of the goods and/or services. The gaming establishment fund management system then proceeds to modify a balance of the gaming establishment account to reflect a debit (which factors in any amount offset by any incentives) to cover the purchased goods and/or services. The amount to cover the purchased goods and/or services with funds in the gaming establishment account plus any applicable funds offered via the use of any applied incentives are subsequently transferred, as part of a settlement process, from a backing account associated with the gaming establishment account to a retailer bank account associated with the retailer.

In addition to updating one or more balances associated with the user (i.e., updating the gaming establishment account for part or all of the amount to fund the purchase) and updating one or more gaming establishment fund management system accounts which are independent of the gaming establishment account associated with the user to compensate for part or all of any discount applied and/or surplus provided, the gaming establishment fund management system communicates one or more authorization messages of the sale transaction of the goods and/or services to the debit card issuer system which communicates such authorization messages to the retail point-of-sale system to complete the sale of the goods and/or services. Such a completed purchase of the goods and/or services is associated with a transaction identification which one or more components of the system store for reporting purposes.

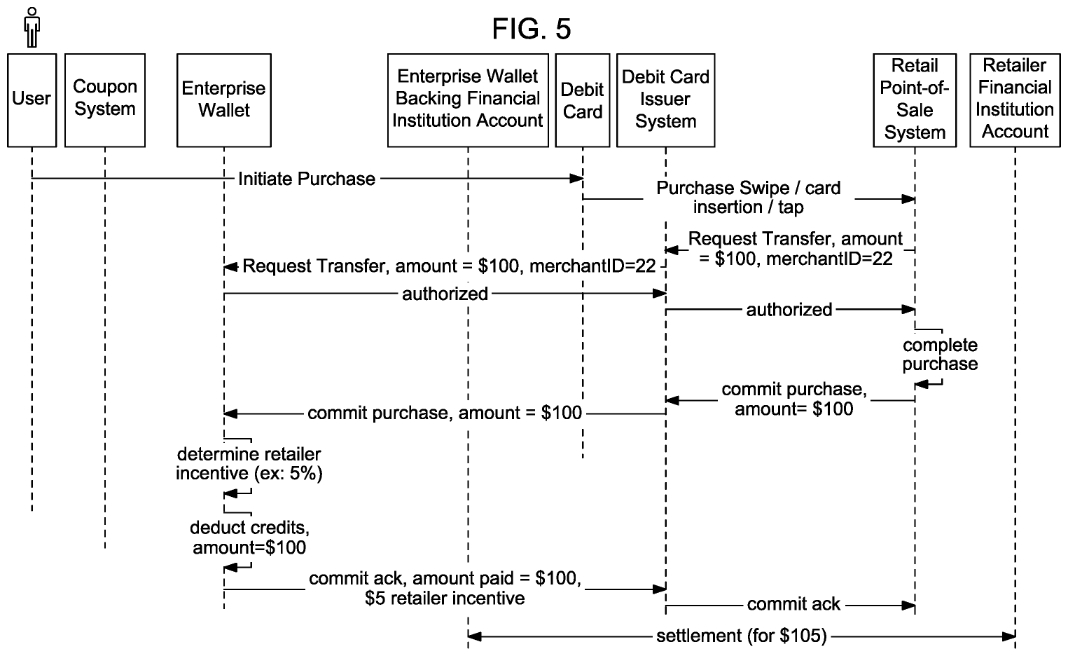

Accordingly, in various embodiments, the system of the present disclosure enables one or more incentives to be applied in association with a debit card that is used to access funds in a gaming establishment account to potentially purchase goods and/or services from a retailer, such as a retailer operating independent of any gaming establishment. In one such example, as seen in FIG. 5 (which illustrates the described interactions between the user, the gaming establishment fund management system, the debit card issuer system, the retail point-of-sale system and the financial institutions that maintain accounts associated with the gaming establishment fund management system and the retail point-of-sale system to settle fund transfers), certain embodiments of offering incentives in association with the use of a debit card to access gaming establishment held funds to complete a purchase transaction includes presenting the debit card to a retail point-of-sale system which interfaces with the debit card issuer system that operates with the gaming establishment fund management system (i.e., the enterprise wallet) to approve or deny the attempted purchase transaction (when factoring in any determined incentive) and communicate information back to the debit card issuer system and the retail point-of-sale system.

In certain embodiments, since the gaming establishment fund management system utilizes one or more accounts which are independent of any gaming establishment accounts associated with the user, the gaming establishment fund management system maintains separate accounts on a per retail establishment basis. In another embodiment, the gaming establishment fund management system separately maintains a ledger of purchases and/or a running loyalty total in which the gaming establishment fund management system utilizes to pay one or more partner retail establishment their accrued incentives on a periodic basis based upon the amount accrued during that period.

In certain additional or alternative embodiments, in view of the positive ramifications to a retail establishment for partnering with a gaming establishment to gain access to the volume of customers the gaming establishment can potentially bring into a retailer establishment by reaching out to gaming establishment customers in a given geographic area and invite them to visit a retail establishment, the retail establishment is incentivized to participate in the partnership with the gaming establishment. For example, in exchange for a gaming establishment marketing, such as via mailers and electronic communications, to their existing customer base to bring customers to a retail establishment, the retail establishment compensates the gaming establishment for the gaming establishment's marketing expenses and/or customer acquisition costs. In different embodiments, the system of the present disclosure tracks purchases made using the debit card associated with the gaming establishment account and the retail establishment compensates the gaming establishment for driving such sales in association with the partnership.

In certain embodiments, while the use of a debit card to access funds associated with a gaming establishment account includes the gaming establishment fund management system modifying the balance of the gaming establishment account based on such debit card facilitated access and any applicable coupons and/or discounts applied, the settlement of such funds with the retailer occurs upon a settlement event. In these embodiments, while the realization of the benefit from the coupon and/or discount occurs at the time of the retail purchase (i.e., the user does not need to wait to receive the benefit after the purchase and/or take any additional actions after the purchase to realize the benefits), the settlement of funds associated with the retail purchase occurs responsive to an occurrence of a settlement event. Such a settlement event occurs automatically at a preset interval or point in time, automatically in real time, and/or responsive to one or more inputs received to initiate the settlement event. In these embodiments, upon an occurrence of the settlement event, a financial institution associated with the gaming establishment fund management system operates with a financial institution associated with the retailer to cause a transfer of an amount of funds between the gaming establishment account maintained by the gaming establishment fund management system and the financial institution account associated with the retailer. In these embodiments, since certain jurisdictions require that the amount of funds associated with one or more gaming establishment accounts maintained by a gaming establishment fund management system for one or more users are secured by a corresponding amount of funds in one or more financial institution accounts for the gaming establishment, to account for the debit card facilitated use of funds flowing to and/or from such a gaming establishment account, the system causes, either in association with each debit card facilitated transaction or in association with a plurality of debit card facilitated transactions, the transfer of funds between the different financial institution accounts associated with the gaming establishment and the retailer where the debit card was used. Such settlement transfers not only ensure that the retailer is paid for the goods and/or services purchased using the debit card (or alternative the user is credited for the refund transaction associated with the credit card), but such settlement transfers further ensure that the amounts maintained in the gaming establishment account maintained by the gaming establishment comply with jurisdictional requirements by corresponding with the amounts maintained in the one or more associated financial institution accounts.

It should be thus appreciated that unlike prior payment solutions in which if a user wanted to access their funds held in a casino account at a retail establishment outside of the casino, the user needed to first transfer their funds to a bank account (after which the user can then pay at that retail establishment outside of the casino using a debit card or credit card associated with their bank account), or alternatively first transfer their funds to an electronic wallet (after which the user can use a pre-paid debit card associated with their electronic wallet to pay at that retail establishment outside of the casino), the present disclosure enables a user to maintain their funds in a casino account while still availing themselves of the use of a debit card (issued separate from the casino) for purchases made outside of the casino with the added benefit of access to certain discounts for the use of such a debit card. Such discounts may be available via a benefit offered by the gaming establishment (provided to the user and/or the partner retail establishment), a benefit offered by the partner retail establishment (provided to the user and/or the gaming establishment), and/or a redemption by the user of a gaming establishment benefit associated with the user, such as a redemption of loyalty points by the user. In these different embodiments, by employing targeted discounting for partner retail establishments and employing the use of funds held in a gaming establishment account to make purchases at the partner retail establishment, the system of the present disclosure enables the user to realize the benefits of maintaining funds in a gaming establishment account while still having access to such funds when needed. In other words, by integrating a pre-paid open-loop debit card with funding from one or more gaming establishment accounts that directly accounts for any applicable benefits, the present disclosure enables such a debit card to function as an interface to remotely access funds from such gaming establishment accounts while offering certain benefits for such access. In addition to the benefits of offering discounts (e.g., via the application of coupons), such a configuration further enables a user with funds in a gaming establishment account, such as a cashless wagering account, to access the network payment processors accessible with a debit card without needing to manually arrange a pre-set transfer of any amounts of funds from the gaming establishment account to another account associated with the debit card to gain such access. This configuration saves users time (e.g., no time needs to be spent transferring funds from a gaming establishment account to a banking account associated with a debit card or waiting a dedicated amount of time for such a transfer to be completed) and offers operational efficiencies (e.g., reducing the number of touchpoints funds must flow through before they may be used) compared to prior payment solutions involving funds in a casino account.

It should be further appreciated that unlike these prior systems, the present disclosure bypasses the requirement for external transfers and enables the debit card issuer system to interact, in real time, with the gaming establishment fund management system such that the funds available in a gaming establishment account are available for use employing a debit card as a gateway to such funds. As such, the system of the present disclosure offers, in addition to the benefits of real-time coupon deployment, the benefits of debit card transactions without the fund transfer friction previously encountered in moving funds from a gaming establishment account to a banking account associated with the debit card. Such a configuration provides the user greater control over their funds and, via the use of one or more coupons, more retained funds after completion of the purchase transaction at the partner retail establishment. Accordingly, in view of the different channels of commerce available both in association with and independent of one or more gaming establishments, the system enables an open loop pre-paid debit card issued by a financial institution to be employed to access funds held in a gaming establishment account and to facilitate the transfer of funds to different accounts associated with different channels of commerce associated with or independent of one or more gaming establishments. Such transfers thus reduce the fund movement friction encountered in using funds held in a gaming establishment account to complete transactions outside of the gaming establishment network while still realizing the benefits of couponing and network payment processors offered by the use of debit cards. Such a configuration of employing an open loop pre-paid debit card to access funds maintained in one or more gaming establishment accounts further facilitates, amongst other benefits, a more cashless environment (e.g., cash does not need to be withdrawn from a gaming establishment account and then brought to a retailer, either internal to or external from the gaming establishment, to purchase goods and/or services) which increases safety (e.g., minimizing users having to carry large sums of cash associated with large sums of money and minimizing such cash being a vehicle to spread potentially harmful contagions).

In various embodiments, prior to using zero, one or more coupons and/or discounts with funds in a gaming establishment account, such as using funds in a gaming establishment account, to purchase goods and/or services using a debit card associated with the gaming establishment account, the system enables the gaming establishment account to be funded from one or more sources. In certain embodiments, the system enables the gaming establishment account to be directly funded from one or more of such sources. In certain embodiments, the system enables the gaming establishment account to be indirectly funded from one or more of such sources, such as by an amount of funds from such sources first being transferred to another gaming establishment account and then such an amount of funds being transferred from the other gaming establishment account to the gaming establishment account.

In certain embodiments, the gaming establishment account is associated with one or more external accounts, such as one or more credit card accounts, one or more debit card accounts and/or one or more third-party maintained accounts (e.g., one or more PayPal® accounts or Venmo® accounts). In certain embodiments, the gaming establishment account is associated with a gaming establishment or a group of gaming establishments, wherein the user establishes a gaming establishment account by a deposit of funds (such as at a kiosk) to be subsequently utilized in association with the mobile device application. In other embodiments, the gaming establishment account is funded via a mobile device electronic fund transfer, such using Apple Pay™ or Android Pay™. It should be appreciated that in different embodiments, the system utilizes a mobile device running a mobile device application, a kiosk, an EGM, a gaming table component, a service window displayed by a gaming device (e.g., a remote host controlled service window displayed by an EGM) and/or a gaming establishment interface to facilitate the transfer of funds from a third-party account. In certain embodiments, the system enables funds to be deposited in a gaming establishment account via activating a line of credit associated with the user.

In certain embodiments, the system enables funds to be deposited in a gaming establishment account, via a gaming device, such as an EGM and/or via a non-gaming device, such as a kiosk. In certain embodiments, the system enables a user that has an amount of cash to utilize a gaming device and/or a non-gaming device to convert the cash to an amount deposited into a gaming establishment account (which may be subsequently transferred utilizing a mobile device application). In other embodiments, the system enables funds to be deposited in a gaming establishment account via a gaming device and/or a non-gaming device that accepts printed ticket vouchers. In these embodiments, the system enables a user that has one or more printed ticket vouchers to utilize a gaming device and/or a non-gaming device to convert the printed ticket voucher to an amount deposited into a gaming establishment account (which may be subsequently transferred utilizing a mobile device application).

In certain embodiments, the system enables funds to be deposited in a gaming establishment account via a gaming establishment interface, such as a gaming establishment cage or desk. In certain embodiments, the system enables a user that has an amount of cash to utilize a gaming establishment interface, such as a gaming establishment cage or desk to convert the cash to an amount deposited into a gaming establishment account (which may be subsequently transferred utilizing a mobile device application). In other embodiments, the system enables funds to be deposited in a gaming establishment account via a gaming establishment interface that accepts printed ticket vouchers. In these embodiments, the system enables a user that has one or more printed ticket vouchers to utilize a gaming establishment interface to convert the printed ticket voucher to an amount deposited into a gaming establishment account (which may be subsequently transferred utilizing a mobile device application).

In certain embodiments, the gaming establishment account is associated with funds associated with one or more virtual ticket vouchers. In certain embodiments, the system enables a user associated with an amount of virtual ticket vouchers to utilize a gaming device (e.g., an EGM, or a component of an EGM), a non-gaming device (e.g., a kiosk), a mobile device running a mobile device application, and/or a gaming establishment interface to convert the virtual ticket vouchers to an amount deposited into a gaming establishment account.

It should be appreciated that the electronic fund data transfers of the present disclosure may occur in addition to or as an alternative from cash-based fund transfers and/or ticket voucher-based fund transfers. In one such embodiment, an amount of funds transacted at a retail point-of-sale terminal is funded via any of an electronic fund transfer, a cash-based fund transfer or a ticket voucher-based fund transfer. In another embodiment, an amount of funds In another embodiment, an amount of funds transacted at a retail point-of-sale terminal is funded via an electronic fund transfer or a cash-based fund transfer (but is not funded via any ticket voucher-based fund transfer). In another embodiment, an amount of funds transacted at a retail point-of-sale terminal is funded via an electronic fund transfer or a ticket voucher-based fund transfer (but is not funded via any cash-based fund transfer). In another embodiment, an amount of funds transacted at a retail point-of-sale terminal is funded via an electronic fund transfer (but is not funded via a cash-based fund transfer nor a ticket voucher-based fund transfer).

It should be further appreciated that any functionality or process of the present disclosure may be implemented via one or more servers (associated with or independent of any component of any system disclosed herein), one or more non-gaming establishment devices (e.g., a point-of-sale terminal of a retailer located external to and independent of a gaming establishment), a mobile device application, one or more gaming establishment devices (e.g., a gaming device such as an EGM or a non-gaming device such as a point-of-sale terminal of a retailer located within or otherwise associated with a gaming establishment), and/or one or more components of a gaming establishment system (such as a component of a gaming establishment management system supported by or otherwise located inside a gaming establishment device and/or a non-gaming establishment device). Accordingly: (i) while certain functions, features or processes are described herein as being performed by a non-gaming establishment device, such functions, features or processes may alternatively be performed by one or more servers, or one or more mobile device applications, one or more gaming establishment devices, and/or one or more gaming establishment components, and (ii) while certain functions, features or processes are described herein as being performed by one or more servers (e.g., a server of a debit card issuer system, a server of a gaming establishment fund management system, a server of a coupon system, and/or a server of a retail point-of-sale system), such functions, features or processes may alternatively be performed by one or more gaming establishment devices, one or more components of a gaming establishment system, one or more non-gaming establishment devices, one or more mobile device applications, or one or more gaming establishment components.

In certain embodiments, the above-described embodiments of the present disclosure may be implemented in accordance with or in conjunction with zero, one or more components of a gaming establishment fund management system (e.g., a cashless wagering system or a gaming establishment retail system); zero, one or more components of a debit card issuer system; zero, one or more components of a gaming establishment patron management system; zero, one or more components of a retail point-of-sale system; and/or zero, one or more gaming establishment devices. In these embodiments, such components of the gaming establishment fund management system, the debit card issuer system, the coupon system, the gaming establishment patron management system, the retail point-of-sale system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system, the component of the debit card issuer system, the component of the coupon system, the component of the retail point-of-sale system and/or the gaming establishment device; (3) accessing memory to configure or reconfigure parameters in the memory according to indicia read from the component of the gaming establishment fund management system, the component of the debit card issuer system, the component of the coupon system, the component of the retail point-of-sale system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system, the component of the debit card issuer system, the component of the coupon system, the component of the retail point-of-sale system and/or the gaming establishment device, while in other embodiments, at least one component of the controller resides outside of the housing of the component of the gaming establishment fund management system, the component of the debit card issuer system, the component of the coupon system, the component of the retail point-of-sale system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system, the component of the debit card issuer system, the component of the coupon system, the component of the retail point-of-sale system and/or the gaming establishment device disclosed herein. In certain embodiments, the at least one memory device resides within the housing of the component of the gaming establishment fund management system, the component of the debit card issuer system, the component of the coupon system, the component of the retail point-of-sale system and/or the gaming establishment device, while in other embodiments at least one component of the at least one memory device resides outside of the housing of the component of the gaming establishment fund management system, the component of the debit card issuer system, the component of the coupon system, the component of the retail point-of-sale system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system, the component of the debit card issuer system, the component of the coupon system, the component of the retail point-of-sale system and/or the gaming establishment device; (2) associations between configuration indicia read from the component of the gaming establishment fund management system, the component of the debit card issuer system, the component of the coupon system, the component of the retail point-of-sale system and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system, the component of the debit card issuer system, the component of the coupon system, the component of the retail point-of-sale system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system, the component of the debit card issuer system, the component of the coupon system, the component of the retail point-of-sale system and/or the gaming establishment device to control the component of the gaming establishment fund management system, the component of the debit card issuer system, the component of the coupon system, the component of the retail point-of-sale system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the gaming establishment fund management system, the component of the debit card issuer system, the component of the coupon system, the component of the retail point-of-sale system and/or the gaming establishment device through any suitable data network described above (such as an Internet or intranet).

The at least one memory device also stores a plurality of device drivers. Examples of different types of device drivers include device drivers for the component of the gaming establishment fund management system, the component of the debit card issuer system, the component of the coupon system, the component of the retail point-of-sale system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system, the component of the debit card issuer system, the component of the coupon system, the component of the retail point-of-sale system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment fund management system, the component of the debit card issuer system, the component of the coupon system, the component of the retail point-of-sale system and/or the gaming establishment device loads the new device driver from the at least one memory device to enable communication with the new device. For instance, one type of card reader in the component of the gaming establishment fund management system, the component of the debit card issuer system, the component of the coupon system, the component of the retail point-of-sale system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment fund management system, the component of the debit card issuer system, the component of the coupon system, the component of the retail point-of-sale system and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment fund management system, the component of the debit card issuer system, the component of the coupon system, the component of the retail point-of-sale system and/or the gaming establishment device. In various embodiments, the display devices serve as digital glass configured to aspects of the gaming establishment in which the component of the gaming establishment fund management system, the component of the debit card issuer system, the component of the coupon system, the component of the retail point-of-sale system and/or the gaming establishment device is located. In various embodiments, the component of the gaming establishment fund management system, the component of the debit card issuer system, the component of the coupon system, the component of the retail point-of-sale system and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the gaming establishment fund management system, the component of the debit card issuer system, the component of the coupon system, the component of the retail point-of-sale system and/or the gaming establishment device receives an actuation, the component of the gaming establishment fund management system, the component of the debit card issuer system, the component of the coupon system, the component of the retail point-of-sale system and/or the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the gaming establishment fund management system, the component of the debit card issuer system, the component of the coupon system, the component of the retail point-of-sale system and/or the gaming establishment device provides dynamic sounds coupled with attractive multimedia images displayed on one or more of the display devices to provide an audio-visual representation or to otherwise display full-motion video with sound to attract users to the component of the gaming establishment fund management system, the component of the debit card issuer system, the component of the coupon system, the component of the retail point-of-sale system and/or the gaming establishment device. In certain embodiments, the component of the gaming establishment fund management system, the component of the debit card issuer system, the component of the coupon system, the component of the retail point-of-sale system and/or the gaming establishment device displays a sequence of audio and/or visual attraction messages during idle periods to attract potential users to the component of the gaming establishment fund management system, the component of the debit card issuer system, the component of the coupon system, the component of the retail point-of-sale system and/or the gaming establishment device. The videos may be customized to provide any appropriate information.

The at least one input device may include any suitable device that enables an input signal to be produced and received by the at least one processor of the component of the gaming establishment fund management system, the component of the debit card issuer system, the component of the coupon system, the component of the retail point-of-sale system and/or the gaming establishment device. In one embodiment, the at least one input device includes a payment device configured to communicate with the at least one processor of the component of the gaming establishment fund management system, the component of the debit card issuer system, the component of the coupon system, the component of the retail point-of-sale system and/or the gaming establishment device to fund the component of the gaming establishment fund management system, the component of the debit card issuer system, the component of the coupon system, the component of the retail point-of-sale system and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the gaming establishment fund management system, the component of the debit card issuer system, the component of the coupon system, the component of the retail point-of-sale system and/or the gaming establishment device to be funded via an electronic funds transfer, such as a transfer of funds from a bank account. In another embodiment, the component of the gaming establishment fund management system, the component of the debit card issuer system, the component of the coupon system, the component of the retail point-of-sale system and/or the gaming establishment device includes a payment device configured to communicate with a mobile device of a user, such as a mobile phone, a radio frequency identification tag, or any other suitable wired or wireless device, to retrieve relevant information associated with that user to fund the component of the gaming establishment fund management system, the component of the debit card issuer system, the component of the coupon system, the component of the retail point-of-sale system and/or the gaming establishment device. When the component of the gaming establishment fund management system, the component of the debit card issuer system, the component of the coupon system, the component of the retail point-of-sale system and/or the gaming establishment device is funded, the at least one processor determines the amount of funds entered and displays the corresponding amount.

In various embodiments, the at least one input device includes a plurality of buttons that are programmable by the component of the gaming establishment fund management system, the component of the debit card issuer system, the component of the coupon system, the component of the retail point-of-sale system and/or the gaming establishment device operator to, when actuated, cause the component of the gaming establishment fund management system, the component of the debit card issuer system, the component of the coupon system, the component of the retail point-of-sale system and/or the gaming establishment device to perform particular functions. For instance, such buttons may be hard keys, programmable soft keys, or icons icon displayed on a display device of the component of the gaming establishment fund management system, the component of the debit card issuer system, the component of the coupon system, the component of the retail point-of-sale system and/or the gaming establishment device that are actuatable via a touch screen of the component of the gaming establishment fund management system, the component of the debit card issuer system, the component of the coupon system, the component of the retail point-of-sale system and/or the gaming establishment device or via use of a suitable input device of the component of the gaming establishment fund management system, the component of the debit card issuer system, the component of the coupon system, the component of the retail point-of-sale system and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the gaming establishment fund management system, the component of the debit card issuer system, the component of the coupon system, the component of the retail point-of-sale system and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment fund management system, the component of the debit card issuer system, the component of the coupon system, the component of the retail point-of-sale system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment fund management system, the component of the debit card issuer system, the component of the coupon system, the component of the retail point-of-sale system and/or the gaming establishment device, such as one or more rechargeable power sources (e.g., rechargeable batteries) located at the component of the gaming establishment fund management system, the component of the debit card issuer system, the component of the coupon system, the component of the retail point-of-sale system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment fund management system, the component of the debit card issuer system, the component of the coupon system, the component of the retail point-of-sale system and/or the gaming establishment device; detecting the presence and/or identity of various persons (e.g., users, casino employees, etc.), devices (e.g., user input devices), and/or systems within a predetermined proximity to the component of the gaming establishment fund management system, the component of the debit card issuer system, the component of the coupon system, the component of the retail point-of-sale system and/or the gaming establishment device.

The at least one data preservation component is configured to detect or sense one or more events and/or conditions that, for example, may result in damage to the component of the gaming establishment fund management system, the component of the debit card issuer system, the component of the coupon system, the component of the retail point-of-sale system and/or the gaming establishment device and/or that may result in loss of information associated with the component of the gaming establishment fund management system, the component of the debit card issuer system, the component of the coupon system, the component of the retail point-of-sale system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the gaming establishment fund management system, the component of the debit card issuer system, the component of the coupon system, the component of the retail point-of-sale system and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment fund management system, the component of the debit card issuer system, the component of the coupon system, the component of the retail point-of-sale system and/or the gaming establishment device. For example, in one implementation, the at least one geolocation module is configured to receive GPS signal information for use in determining the position or location of the component of the gaming establishment fund management system, the component of the debit card issuer system, the component of the coupon system, the component of the retail point-of-sale system and/or the gaming establishment device. In another implementation, the at least one geolocation module is configured to receive multiple wireless signals from multiple remote devices (e.g., component of the gaming establishment fund management system, the gaming establishment patron management system, the retail point-of-sale system and/or the gaming establishment devices, servers, wireless access points, etc.) and use the signal information to compute position/location information relating to the position or location of the component of the gaming establishment fund management system, the component of the debit card issuer system, the component of the coupon system, the component of the retail point-of-sale system and/or the gaming establishment device.

The at least one user identification module is configured to determine the identity of the current user or current owner of the component of the gaming establishment fund management system, the component of the debit card issuer system, the component of the coupon system, the component of the retail point-of-sale system and/or the gaming establishment device. For example, in one embodiment, the current user is required to perform a login process at the component of the gaming establishment fund management system, the component of the debit card issuer system, the component of the coupon system, the component of the retail point-of-sale system and/or the gaming establishment device in order to access one or more features. Alternatively, the component of the gaming establishment fund management system, the component of the debit card issuer system, the component of the coupon system, the component of the retail point-of-sale system and/or the gaming establishment device is configured to automatically determine the identity of the current user based on one or more external signals, such as an RFID tag or badge worn by the current user and that provides a wireless signal to the component of the gaming establishment fund management system, the component of the debit card issuer system, the component of the coupon system, the component of the retail point-of-sale system and/or the gaming establishment device that is used to determine the identity of the current user. In at least one embodiment, various security features are incorporated into the component of the gaming establishment fund management system, the component of the debit card issuer system, the component of the coupon system, the component of the retail point-of-sale system and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment fund management system, the component of the debit card issuer system, the component of the coupon system, the component of the retail point-of-sale system and/or the gaming establishment device.

In various embodiments, the component of the gaming establishment fund management system, the component of the debit card issuer system, the component of the coupon system, the component of the retail point-of-sale system and/or the gaming establishment device includes a plurality of communication ports configured to enable the at least one processor of the component of the gaming establishment fund management system, the component of the debit card issuer system, the component of the coupon system, the component of the retail point-of-sale system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb sticks, ticket readers, touch screens, trackballs, touchpads, wheels, and wireless communication devices.

As generally described above, in certain embodiments, the component of the gaming establishment fund management system, the component of the debit card issuer system, the component of the coupon system, the component of the retail point-of-sale system and/or the gaming establishment device has a support structure, housing, or cabinet that provides support for a plurality of the input devices and the output devices of the component of the gaming establishment fund management system, the component of the debit card issuer system, the component of the coupon system, the component of the retail point-of-sale system and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor responsive to a receipt, from a component of a debit card issuer, of data associated with a purchase transaction initiated in association with a debit card at a point-of-sale terminal, cause the processor to:
responsive to a determination, based on a gaming establishment account that is independent of any account associated with the debit card, to authorize the purchase transaction in association with a discount obtained in exchange for a gaming establishment asset associated with a user:
decrease a balance of the gaming establishment account by a first amount of funds, the first amount of being based on the purchase transaction and the discount, and
communicate an authorization to the component of the debit card issuer to notify the point-of-sale terminal to complete the purchase transaction, and
responsive to a determination, based on the gaming establishment account, to authorize the purchase transaction independent of any discount obtained in exchange for any gaming establishment asset associated with the user:
decrease the balance of the gaming establishment account by a second amount of funds, the second amount of funds being based on the purchase transaction and being greater than the first amount of funds, and
communicate the authorization to the component of the debit card issuer to notify the point-of-sale terminal to complete the purchase transaction.

2. The system of claim 1, wherein the gaming establishment asset associated with the user comprises a quantity of player tracking points associated with the user.

3. The system of claim 1, wherein the gaming establishment asset associated with the user comprises a portion of a promotional balance associated with the user.

4. The system of claim 1, wherein:
a first user obtains, based on a first rate, a first discount in exchange for a first gaming establishment asset, and
a second, different user obtains, based on a second, different rate, a second, different discount in exchange for the first gaming establishment asset.

5. The system of claim 1, wherein:
a first retail establishment associated with the point-of-sale terminal offers, based on a first rate, a first discount in exchange for a first gaming establishment asset, and
a second, different retail establishment associated with the point-of-sale terminal offers, based on a second, different rate, a second, different discount in exchange for the first gaming establishment asset.

6. The system of claim 1, wherein the memory device stores a plurality of further instructions that, when executed by the processor, cause the processor to automatically exchange a maximum gaming establishment asset associated with the user to obtain a maximum discount.

7. The system of claim 6, wherein the maximum discount cannot exceed a discount limit.

8. The system of claim 1, wherein a transfer of an amount of funds associated with the purchase transaction occurs responsive to a settlement event.

9. The system of claim 1, wherein the point-of-sale terminal comprises a non-gaming establishment retail point-of-sale terminal.

10. A system comprising:
a processor; and
a memory device that stores a plurality of instructions that, when executed by the processor responsive to a receipt, from a component of a debit card issuer, of data associated with a purchase transaction initiated in association with a debit card at a point-of-sale terminal and responsive to receipt, from a component of a player tracking system, of a quantity of player tracking points associated with a user to exchange for a discount on the purchase transaction, cause the processor to:
determine:
if a balance of a gaming establishment account at least equals an amount of funds associated with the purchase transaction modified by an amount associated with the discount, and
if an application of the discount on the purchase transaction complies with a discount limit,
responsive to the balance of the gaming establishment account at least equaling the amount of funds associated with the purchase transaction modified by the amount associated with the discount and the application of the discount on the purchase transaction complying with the discount limit:
decrease the balance of the gaming establishment account based on the purchase transaction modified by the amount associated with the discount, and
communicate an authorization to the component of the debit card issuer to notify the point-of-sale terminal to complete the purchase transaction,
responsive to the balance of the gaming establishment account at least equaling the amount of funds associated with the purchase transaction modified by the amount associated with the discount and the application of the discount on the purchase transaction being in violation of the discount limit, communicate a denial to the component of the debit card issuer to notify the point-of-sale terminal to deny the purchase transaction, and
responsive to the balance of the gaming establishment account being less than the amount of funds associated with the purchase transaction, communicate the denial to the component of the debit card issuer to notify the point-of-sale terminal to deny the purchase transaction.

11. The system of claim 10, wherein the gaming establishment account comprises one of a cashless wagering account and a gaming establishment retail account.

12. A method of operating a system, the method comprising:
responsive to a receipt, from a component of a debit card issuer, of data associated with a purchase transaction initiated in association with a debit card at a point-of-sale terminal and responsive to a determination, based on a gaming establishment account that is independent of any account associated with the debit card, to authorize the purchase transaction in association with a discount obtained in exchange for a gaming establishment asset associated with a user:
decreasing, by a processor, a balance of the gaming establishment account by a first amount of funds, the first amount of being based on the purchase transaction and the discount, and
communicating an authorization to the component of the debit card issuer to notify the point-of-sale terminal to complete the purchase transaction, and
responsive to the receipt, from the component of a debit card issuer, of data associated with the purchase transaction initiated in association with the debit card at the point-of-sale terminal and responsive to a determination, based on the gaming establishment account, to authorize the purchase transaction independent of any discount obtained in exchange for any gaming establishment asset associated with the user:
decreasing, by the processor, the balance of the gaming establishment account by a second amount of funds, the second amount of funds being based on the purchase transaction and being greater than the first amount of funds, and
communicating the authorization to the component of the debit card issuer to notify the point-of-sale terminal to complete the purchase transaction.

13. The method of claim 12, wherein the gaming establishment asset associated with the user comprises a quantity of player tracking points associated with the user.

14. The method of claim 12, wherein the gaming establishment asset associated with the user comprises a portion of a promotional balance associated with the user.

15. The method of claim 12, wherein:
a first user obtains, based on a first rate, a first discount in exchange for a first gaming establishment asset, and
a second, different user obtains, based on a second, different rate, a second, different discount in exchange for the first gaming establishment asset.

16. The method of claim 12, wherein:
a first retail establishment associated with the point-of-sale terminal offers, based on a first rate, a first discount in exchange for a first gaming establishment asset, and
a second, different retail establishment associated with the point-of-sale terminal offers, based on a second, different rate, a second, different discount in exchange for the first gaming establishment asset.

17. The method of claim 12, further comprising automatically exchanging a maximum gaming establishment asset associated with the user to obtain a maximum discount.

18. The method of claim 17, wherein the maximum discount cannot exceed a discount limit.

19. The method of claim 12, wherein a transfer of an amount of funds associated with the purchase transaction occurs responsive to a settlement event.

20. The method of claim 12, wherein the point-of-sale terminal comprises a non-gaming establishment retail point-of-sale terminal.
